(19) United States
(12) Patent Application Publication
(10) Pub. No.: US 2009/0079777 A1
(43) Pub. Date: Mar. 26, 2009

(54) INK JET PRINTING APPARATUS AND INK JET PRINTING METHOD

(75) Inventors: Mitsutoshi Nagamura, Tokyo (JP); Yoshinori Nakajima, Yokohama-shi (JP); Akihiro Kakinuma, Hadano-shi (JP); Eiji Komamiya, Kawasaki-shi (JP); Akihiro Tomida, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/235,138

(22) Filed: Sep. 22, 2008

(30) Foreign Application Priority Data
Sep. 26, 2007 (JP) 2007-249174

(51) Int. Cl. B41J 2/205

(52) U.S. Cl. 347/15

(57) ABSTRACT

An ink jet printing apparatus is provided which can form sharp images while maintaining high grayscale levels even if the images include various kinds of image constitutional elements to be printed by image data having different attributes, such as character, fine line and image data. This invention checks attributes of the input image data corresponding to the image constitutional elements making up the images and also detects edge and non-edge portions of the image constitutional elements. Further, this invention generates print data for printing the edge portions and print data for printing the non-edge portions based on attributes of the input image data corresponding to the image constitutional elements.

### BACKGROUND OF THE INVENTION

1. Field of the Invention

The present invention relates to an ink jet printing apparatus and an ink jet printing method that print an image using an ink ejecting print head.

2. Description of the Related Art

An ink jet printing apparatus that prints on a print medium, because of its capability of printing fast at high dot density, has found many applications as peripheral devices for various equipment, as fixed type printers or as portable printers.

Generally an ink jet printing apparatus has a carriage mounting a print head to eject ink droplets from a plurality of ejection ports and an ink tank; a print medium transport means to transport the print medium; and a control means to control these. The printing apparatus causes the carriage-mounted print head to eject ink as it moves in a scan direction perpendicular to a print medium transport direction. Between the print head scan operations, the print medium is moved in the transport direction a distance equal to a printing width. By repeating this process of the print head scan followed by the print medium transport operation, the printing apparatus can form an image on the entire print medium.

Such an ink jet printing apparatus is required to be able to print images with high sharpness and high grayscale level. To this end, there has been available a technique of making edge portions of an image clear and increasing a grayscale level of its non-edge portions by detecting the edge portions and non-edge portions of the image and differentiating maximum print duties of the edge portions and the non-edge portions (Japanese Patent Laid-Open No. 2007-176158).

With the method of Japanese Patent Laid-Open No. 2007-176158, however, the maximum print duties of the edge portions and non-edge portions of an image are determined equally regardless of differences in attributes between character portions or picture portions. Therefore, optimum edge/non-edge processing cannot be performed on images (characters and pictures) with different attributes. For example, processing on the edge portions cannot be changed between character portions and picture portions. More specifically, it is not possible to perform processing that enhances sharpness in edge portions of characters while at the same time executing processing that enhances grayscale level in edge portions of pictures. As described above, since the conventional technique does not perform the edge/non-edge processing that conforms to the attributes of image data, it cannot obtain grayscale level and sharpness suitable for the attribute of the image.

### SUMMARY OF THE INVENTION

It is an object of the present invention to provide an ink jet printing apparatus that can produce images with high grayscale level and high level of sharpness by performing edge/non-edge processing according to attributes of images, such as characters and lines and picture.

A first aspect of the invention to provides an ink jet printing apparatus that prints an image on a print medium by ejecting ink from a print head according to print data generated based on input image data, comprising: a decision unit that decides attributes of the input image data corresponding to image constitutional elements making up the image; a detector that detects the image constitutional elements as edge portions or non-edge portions; and a generator that generates print data for printing the edge portions and print data for printing the non-edge portions based on attributes of the input image data corresponding to the image constitutional elements.

A second aspect of the invention to provides an ink jet printing apparatus to print an image on a print medium by ejecting ink from a print head according to print data generated based on input image data, comprising: a decision unit that decides attributes of the input image data corresponding to image constitutional elements making up the image; a detector that detects the image constitutional elements as edge portions or non-edge portions; and a thinning unit that thins the non-edge portion data corresponding to the pixels adjoining the edge portions at a thinning ratio that matches an attribute of input image data corresponding to the image constitutional elements.

A third aspect of the invention to provides an ink jet printing method that prints an image on a print medium by ejecting ink from a print head according to print data generated based on input image data, comprising the steps of: checking attributes of the input image data corresponding to image constitutional elements making up the image; detecting the image constitutional elements as edge portions or non-edge portions; and generating print data for printing the edge portions and print data for printing the non-edge portions based on attributes of the input image data corresponding to the image constitutional elements.

Since it performs edge/non-edge processing according to attributes of input image data, this invention can produce images with high level of sharpness and high grayscale level.

Further features of the present invention will become apparent from the following description of exemplary embodiments (with reference to the attached drawings).

### BRIEF DESCRIPTION OF THE DRAWINGS

FIG. 1 is a schematic perspective view showing one embodiment of a color ink jet printing apparatus capable of applying the present invention;

FIG. 2A is a perspective view showing essential portions of a print head used in embodiments;

FIG. 2B schematically illustrates arrays of ejection openings in an ejection port face of each of print heads used in the embodiments;

FIG. 3 is a block diagram showing a schematic configuration of a control system circuit used in the ink jet printing apparatus of a first embodiment;

FIG. 4 is a block diagram showing a function to convert input image data into print data that can be printed by the ink jet printing apparatus of the first embodiment;

FIG. 5 is a block diagram showing a function to execute object data process in the first embodiment;

FIG. 6 is a flow chart showing a sequence of steps in the object data process of FIG. 5;

FIG. 7 is a flow chart showing an operation performed in the first embodiment to detect non-edge portions of print data;

FIGS. 8A-8D schematically illustrate the non-edge portion detection operation performed in the first embodiment;

FIG. 9 is a flow chart showing a sequence of steps in an operation to generate edge/non-edge portion data for each object of the print data in the first embodiment;

FIGS. 10A-10H schematically illustrate an example of edge/non-edge portion data generation operation for each object in FIG. 9;

FIGS. 11A-11N are tables showing an edge/non-edge portion thinning operation in the first embodiment;

FIG. 12 is a block diagram showing a function to convert input image data into print data for printing by the ink jet printing apparatus in a second embodiment of this invention;

FIG. 13 is a flow chart showing a sequence of steps in an operation to detect a specified RGB value of print data in the second embodiment;

FIG. 14 is a block diagram showing a function to execute specified RGB value data processing in the second embodiment;

FIG. 15 is a flow chart in the second embodiment showing a sequence of steps in data processing;

FIG. 16 is a block diagram in a third embodiment of this invention showing a function to convert input image data into print data that can be printed by the ink jet printing apparatus;

FIG. 17 is a flow chart showing a sequence of steps in an operation to detect a specified RGB value of print data in the third embodiment;

FIG. 18 is a flow chart showing a sequence of steps in a boundary thinning process executed in the third embodiment;

FIGS. 19A-19M show data generated by the boundary thinning process of the third embodiment;

FIG. 20 is a block diagram in a fourth embodiment of this invention showing a function to convert input image data into print data;

FIG. 21 is a diagram showing the relationship between FIG. 21A and FIG. 21B;

FIG. 21A is a part of a block diagram in the fourth embodiment showing a function to execute data processing;

FIG. 21B is the other part of the block diagram in the fourth embodiment showing a function to execute data processing; and

FIG. 22 is a flow chart showing a sequence of steps in the data processing of FIG. 21.

### DESCRIPTION OF THE EMBODIMENTS

### First Embodiment

By referring to the accompanying drawings, embodiments of the ink jet printing apparatus according to the present invention will be explained. In the embodiments that follow, a color ink jet printing apparatus capable of forming color images is taken up as an example. It is noted, however, that this invention is not limited to color images but can also be applied to black and white images.

### Overview of Ink Jet Printing Apparatus

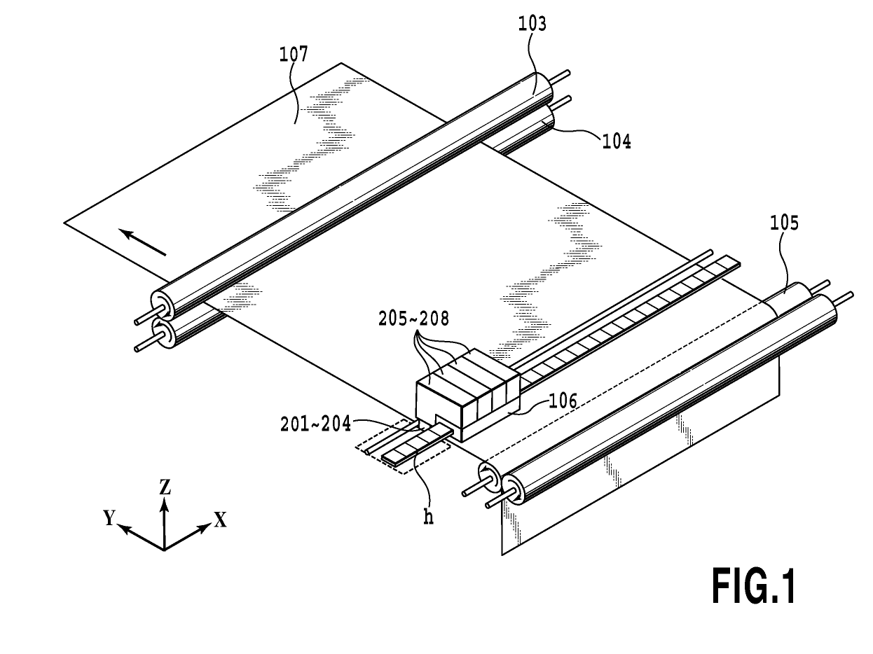

FIG. 1 is a schematic perspective view showing a construction of one embodiment of a color ink jet printing apparatus that can apply the present invention. Ink tanks 205-208 accommodate four color inks (black (K), cyan (C), magenta (M) and yellow (Y) respectively) and supply them to print heads 201-204. The print heads 201-204 correspond to the four color inks and can eject these inks supplied from the ink tanks 205-208.

A conveying roller 103 conveys a print medium 107 by clamping the print medium between it and an auxiliary roller 104 as it rotates. The conveying roller 103 also has a function to hold the print medium (print sheet) 107. A carriage 106 can mount the ink tank 205-208 and the print head 201-204 and reciprocally move in an X direction carrying the print head and ink tanks. As the carriage 106 reciprocates, the print head ejects ink to print an image on a print medium. When the print head 201-204 is not performing the printing operation, as during a recovery operation, the carriage 106 is controlled to move to a home position h shown in a dotted line in the figure for standby.

Upon receiving a print start instruction, the print head 201-204, situated at the home position of FIG. 1 along with the carriage 106 before the start of the printing operation, moves in an X direction in the figure while at the same time ejecting ink to form an image on the print medium 107. A single print head scan in the X direction results in an area of the print medium, whose width or height corresponds to an ejection port array length of the print head 201, being printed. After the printing operation by one scan movement of the carriage 106 in the main scan direction (X) is completed, the carriage 106 returns to the home position h before executing the printing operation again by the print head 201-204 as it scans in the X direction. With one printing scan completed, the conveying roller 103 rotates to feed the print medium in a direction of arrow Y in the figure before the subsequent printing scan starts again. By alternately repeating the printing scan of the print head and the feeding of the print medium, an image on the print medium 107 is completed. The printing operation performed by the print head 201-204 is controlled by a control means described later.

In the above example, we have explained a so-called one-way printing, in which the printing operation is done only when the print head scans in a forward direction. The present invention, however, is also applicable to a so-called bidirectional printing in which the print head executes the printing operation during both the forward and backward scans. While in the above example the ink tank 205-208 and the print head 201-204 are mounted in the carriage 106 so that they are separable from each other, it is possible to use a cartridge having the ink tank 205-208 and the print head 201-204 formed integral. It is also possible to use a multicolor print head capable of ejecting multiple color inks.

At the position where the recovery operation is performed are also provided a capping means (not shown) to cap an ejection port face of the print head and a suction means (not shown) to suck out viscous ink and air bubbles from within the capped print head.

By the side of the capping means is provided a cleaning blade or the like (not shown) to wipe the ejection port face of the print head. After the sucking operation, the cleaning blade is protruded into a print head scan path and the print head is moved to wipe off unwanted ink and contamination adhered to the ejection port face of the print head.

### Overview of Print Head

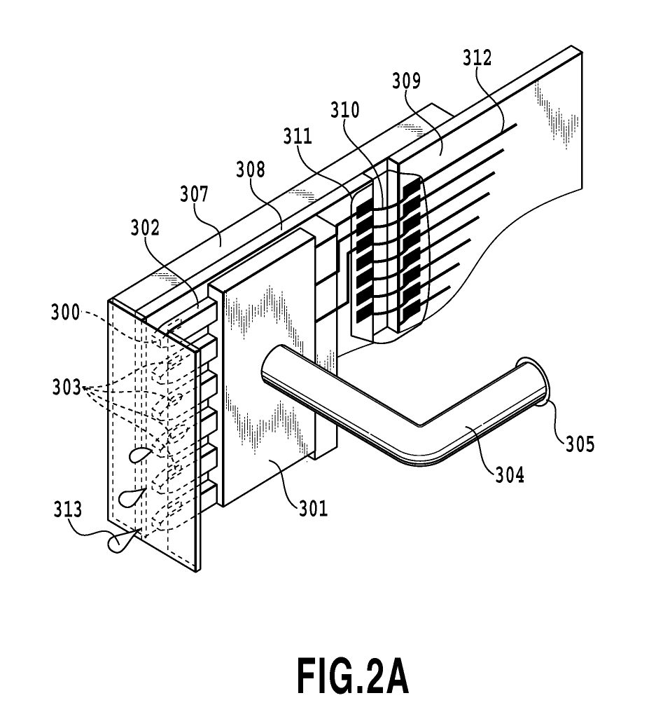

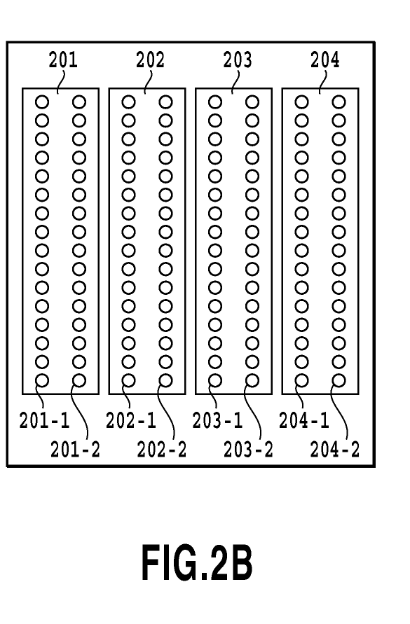

Next, an explanation will be given to one of the print heads 201-204, i.e., 201, by referring to FIG. 2A and FIG. 2B. Other print heads 202-204 also have basically the same construction as the print head 201.

FIG. 2A is a perspective view of an essential portion of the print head 201 of FIG. 1. In FIG. 2A, the print head 201 has a plurality of ejection openings 300 formed in an array at a predetermined pitch. A printing element 303 to generate an ink ejection energy is provided on a wall of each liquid path 302 connecting a common liquid chamber 301 and the ejection openings 300. The printing elements 303 and their drive circuit are fabricated on a silicon substrate using a semiconductor fabrication technique.

A temperature sensor (not shown) and a sub-heater (not shown) are also formed in the same silicon substrate in a process similar to the semiconductor fabrication process. A silicon substrate 308 formed with these electric wirings is bonded to a heat-dissipating aluminum base board 307. A circuit connecting portion 311 on the silicon substrate 308 is connected to a printed circuit board 309 via ultrafine wires 310. A print signal from the color ink jet printing apparatus (also referred to as a printer) is received through a signal circuit 312.

The common liquid chamber 301 is connected to the ink tank 205 (see FIG. 1) through a joint pipe 304 and an ink filter 305. Thus, the common liquid chamber 301 is supplied, for example, a black ink from the ink tank 205. The ink that has been supplied from the ink tank 205 to the common liquid chamber 301, where it is temporarily stored, now enters into the liquid path 302 by capillary attraction, filling it and forming a meniscus at the ejection opening 300. At this time, when the printing element 303 is energized through an electrode (not shown) to heat up, the ink surrounding the printing element 303 is quickly heated forming an air bubble in the liquid path 302. As the bubble expands, a black ink droplet 313 is ejected from the ejection opening 300. Other print heads 202-204 also eject ink in the same way as the print head 201.

FIG. 2B schematically shows arrays of ejection openings formed in the ejection port face of each print head. As shown in the figure, a plurality of arrays (in this embodiment, two arrays) of ejection openings, or simply ejection port arrays, that eject one and the same color ink are provided in each of the print heads 201-204 of this embodiment. That is, the print head 201 is formed with ejection port arrays 201-1, 201-2, the print head 202 with ejection port arrays 202-1, 202-2, the print head 203 with ejection port arrays 203-1, 203-2, and the print head 204 with ejection port arrays 204-1, 204-2.

### Overview of Control System

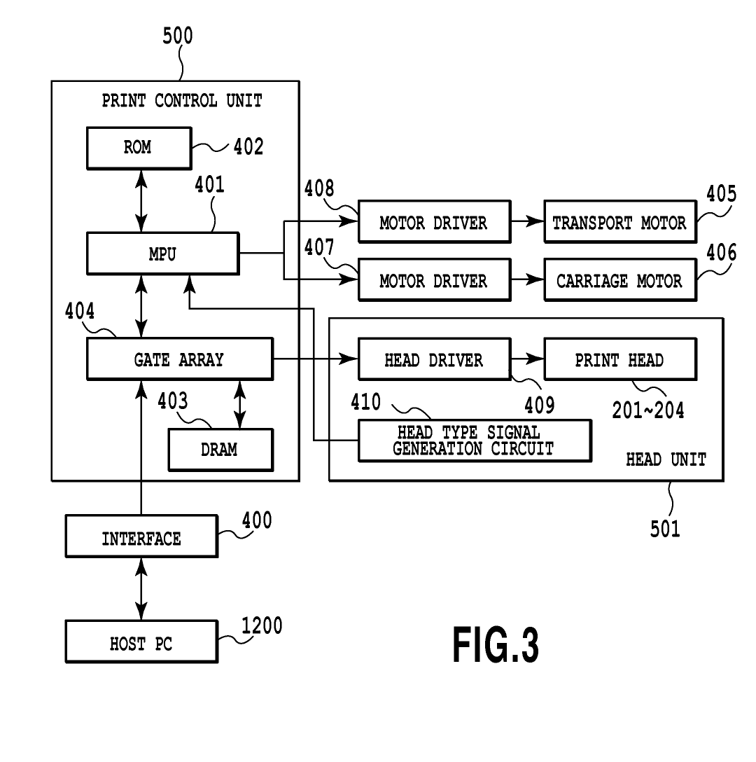

Next, an outline configuration of a print control system circuit in the color ink jet printing apparatus shown in FIG. 1, FIG. 2A and FIG. 2B will be explained by referring to a block diagram of FIG. 3. In FIG. 3, reference number 400 represents an interface for inputting a control signal associated with a print signal and a printing operation. Denoted 401 is an MPU (Micro Processing Unit). Designated 402 is a ROM (Read Only Memory) to store a control program and the like that the MPU 401 executes. A DRAM (Dynamic Random Access Memory) 403 stores various kinds of data (such as print signals supplied to the print heads 201-204 and control signals for printing). The DRAM 403 can also store the number of printed dots and the number of times that the print heads 201-204 have been replaced. Denoted 404 is a gate array that controls print data to be supplied to the print heads 201-204 and also data transfer among the interface 400, MPU 401 and DRAM 403. All these comprise a print control unit 500.

Denoted 406 is a carriage motor to reciprocally move the carriage 106 carrying the print heads 201-204. A transport motor 405 rotates the conveying roller 103 to feed the print medium 107. Motor drivers 408, 407 drive the transport motor 405 and the carriage motor 406, respectively. A plurality of head drivers 409, the number of which corresponds to that of the print heads, drives the print heads 201-204. A head type signal generation circuit 410 gives to the MPU a signal representing the type and the number of the print heads 201-204 mounted in a head unit 501 corresponding to the carriage 106.

Next, how the print data is generated in the above construction will be explained.

In the first embodiment, edge and non-edge portions of an image are detected for each object, based on image attribute information (object information), such as characters, lines and pictures. Then, for each object, a maximum print duties of the edge and non-edge portions are changed. This enables an optimum printing in terms of sharpness and grayscale level to be performed for each object. The print duty is 100% when one dot is formed in every dot forming area. For example, if one dot is formed in each of one-half of all areas, the duty is 50%. If two dots are formed in each of one of all area, the duty is 200%.

In this embodiment, print data for ejecting an ink of the same color (e.g., black ink) is divided into two pieces of print data corresponding to the two ejection port arrays 201-1, 201-2. For example, it is divided into print data for the ejection port array 201-1 and print data for the ejection port array 201-2. Then, based on these divided print data, the two ejection port arrays 201-1, 201-2 eject the ink of the same color, forming an image with dots of the same color ink.

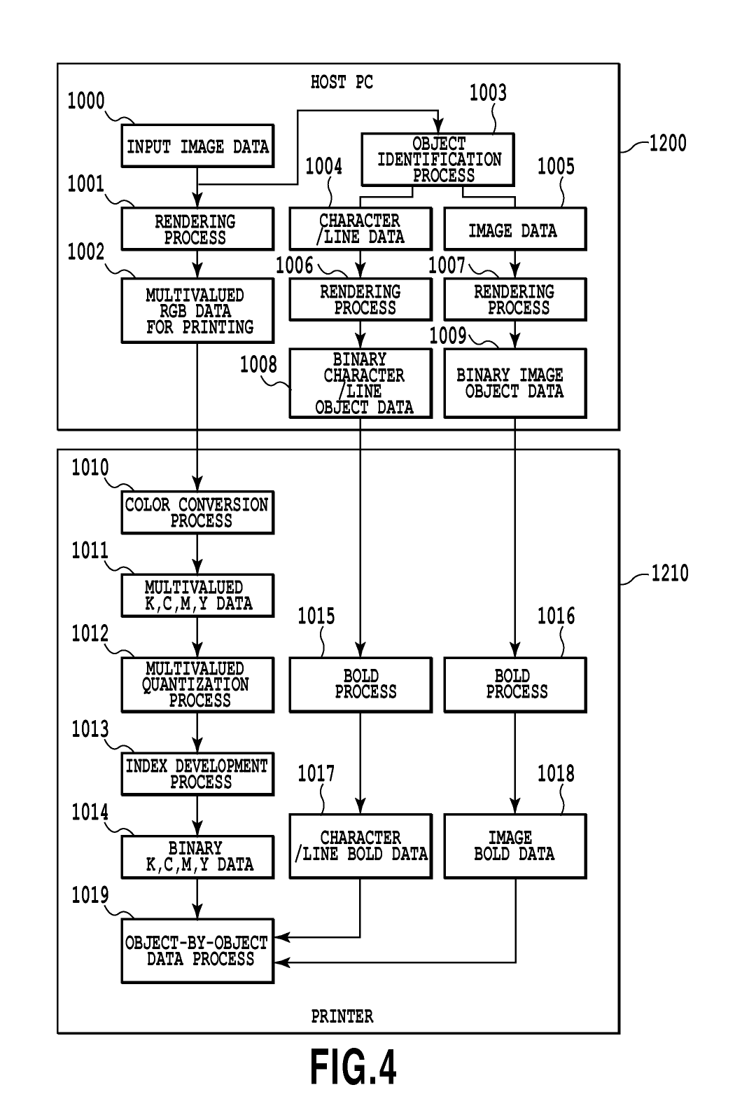

FIG. 4 shows a functional block diagram of a data conversion operation in the first embodiment for converting input image data into print data that can be printed by the ink jet printing apparatus. A printer 1210 shown in FIG. 4 almost corresponds to the print control unit 500 in the schematic configuration of FIG. 3. A host computer (or host PC) 1200 in FIG. 4 transmits and receives data to be described below to and from the printer 1210 through an interface 400.

The host PC 1200 performs a rendering process 1001 at a resolution of 600 dpi on input RGB data (input image data) 1000 received from an application. This generates multivalued (in this embodiment, 256-value) print RGB data 1002. Based on the input RGB data 1000, an object identification process 1003 is performed on a plurality of kinds of image constitutional elements in an image to be printed—character/line objects and image objects (e.g., bit map data). This is followed by rendering process 1006, 1007 being executed on character/line object data 1004 and image object data 1005. As a result, binary character/line object data 1008 (data generated by combining character and line object data) and binary image object data 1009 are generated at a resolution of 600 dpi. The generated multivalued RGB data 1002 and the binary object data 1008, 1009 are transferred to the printer 1210. At this time, every piece of the image data belongs to one of the character, line and image objects.

The printer 1201 performs a conversion operation 1010 to convert the multivalued RGB data 1002 into multivalued KCMY data 1011. The converted KCMY data 1011 is subjected to a quantization process 1012 based on a predetermined quantization method. In this embodiment, the KCMY data is quantized into 5-value data of 600 dpi by an error diffusion method. The quantized 5-value KCMY data is then developed by an index development process 1013 into 1200-dpi, binary KCMY data 1014 that can be printed by the print heads. The index development process 1013 uses a matrix dot array data for each value of the 5-value KCMY data and outputs a dot matrix pattern according to the value of 5-value KCMY data. In this embodiment, the 5-value data is developed into a 2×2 dot matrix. The character/line data 1004 and image data 1005, on the other hand, are subjected to bold process 1015, 1016 to generate character/line bold data 1017 and image bold data 1018. In this embodiment the bold process is performed to match the image data of 600 dpi to the print data of 1200 dpi, which is the resolution of the printer.

Finally, based on the binary KCMY data 1014, character/line bold data 1017 and image bold data 1018, object-by-object data process 1019 to be described later in detail is performed.

While in this first embodiment the image data processing has been described to be divided between the host PC 1200 and the printer 1210, the present invention is not limited to this configuration. For example, all the processing shown in FIG. 4 may be executed by the printer 1210. The only requirement is that the above image data processing be able to be performed in the ink jet printing system comprised of the host 1200 and the printer 1210.

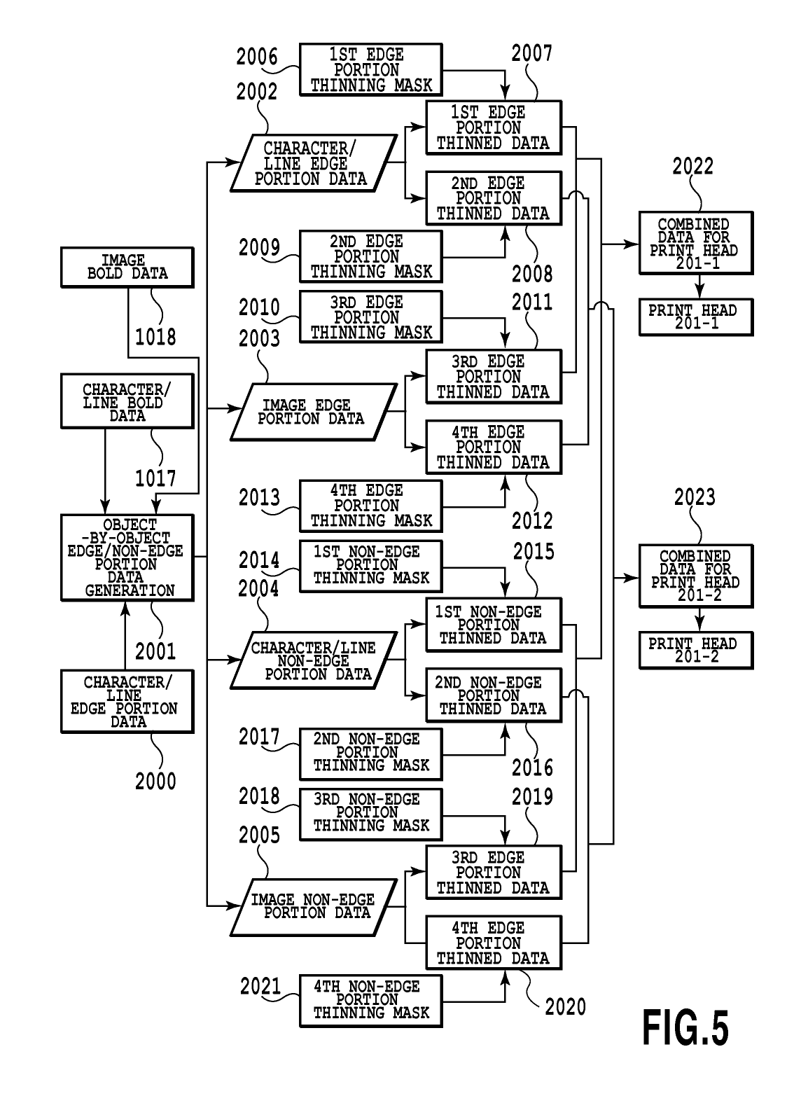

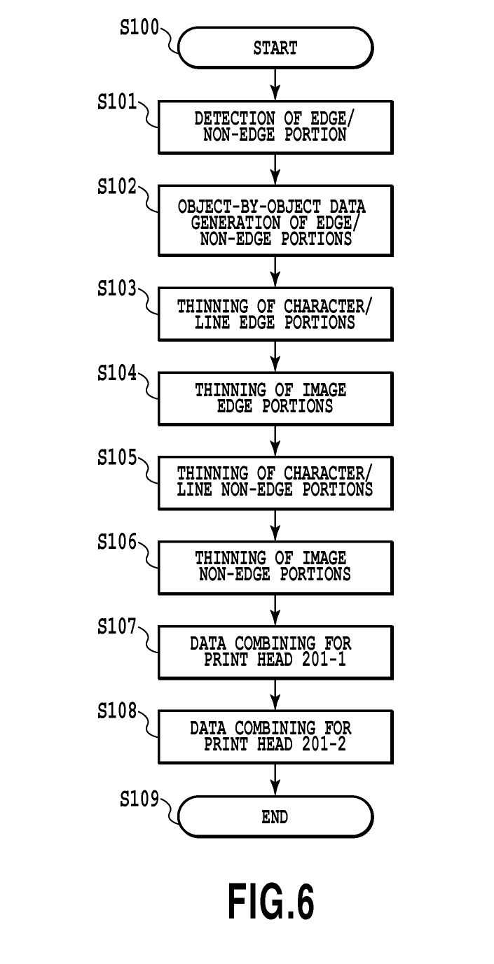

FIG. 5 is an overall functional block diagram showing object data process executed in the first embodiment. FIG. 6 is a flow chart showing a sequence of steps in the object data process of FIG. 5. In the following explanation, an example case is taken up in which two print heads 201-1, 201-2 for black ink are used for printing. In FIG. 5 and FIG. 6, first, an edge/non-edge portion detection operation 2000 is performed (S101) on image constitutional elements (objects) in an image according to print data. Then the print data generation processing on edge portion and non edge portion are performed by respective object (S102). Next, using the character/line bold data 1017 and image bold data 1018, character/line edge portion data 2002, image edge portion data 2003, character/line non-edge portion data 2004 and image non-edge portion data 2005 are generated.

Then, using two masks—a first edge mask 2006 and a second edge mask 2009—a thinning operation is performed on the character/line edge portion data 2002 (S103) to generate thinned first edge portion data 2007 and thinned second edge portion data 2008. Similarly, another thinning operation using a third edge mask 2010 and a fourth edge mask 2013 is performed on the image edge portion data 2003 (S104) to generate thinned third edge portion data 2011 and thinned fourth edge portion data 2012.

Next, the character/line non-edge portion data 2004 is subjected to a thinning operation (S105) using two masks—a first non-edge mask 2014 and a second non-edge mask 2017—to generate thinned first non-edge portion data 2015 and thinned second non-edge portion data 2016. Similarly, the image non-edge portion data 2005 is also subjected to a thinning operation (S106) using two masks—a third non-edge mask 2018 and a fourth non-edge mask 2021—to generate thinned third non-edge portion data 2019 and thinned fourth non-edge portion data 2020.

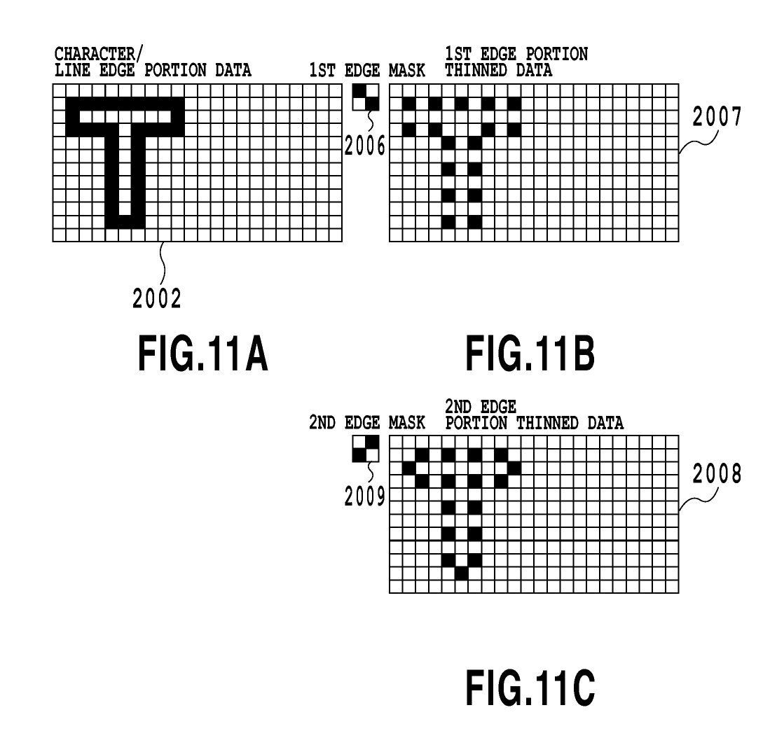

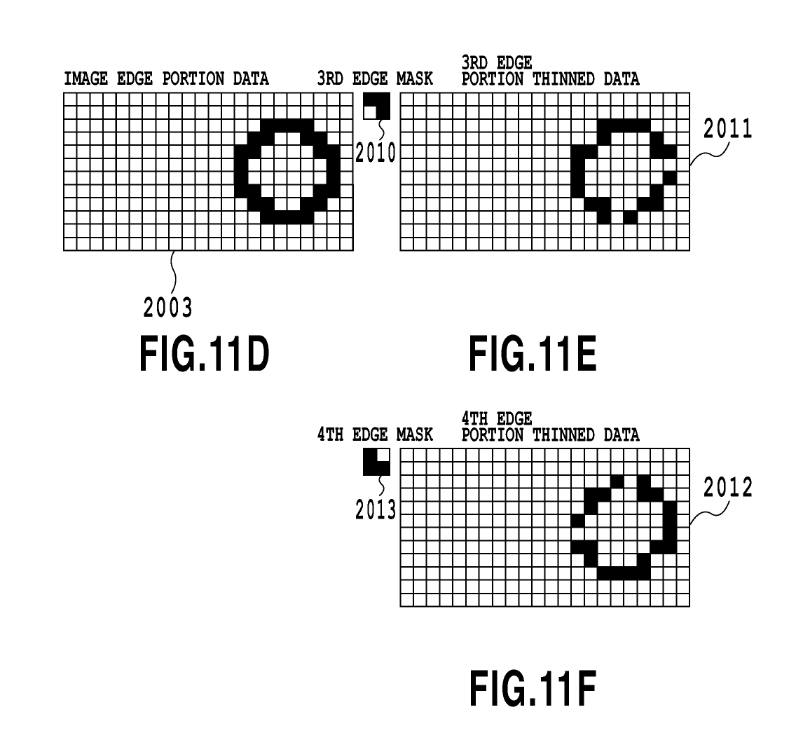

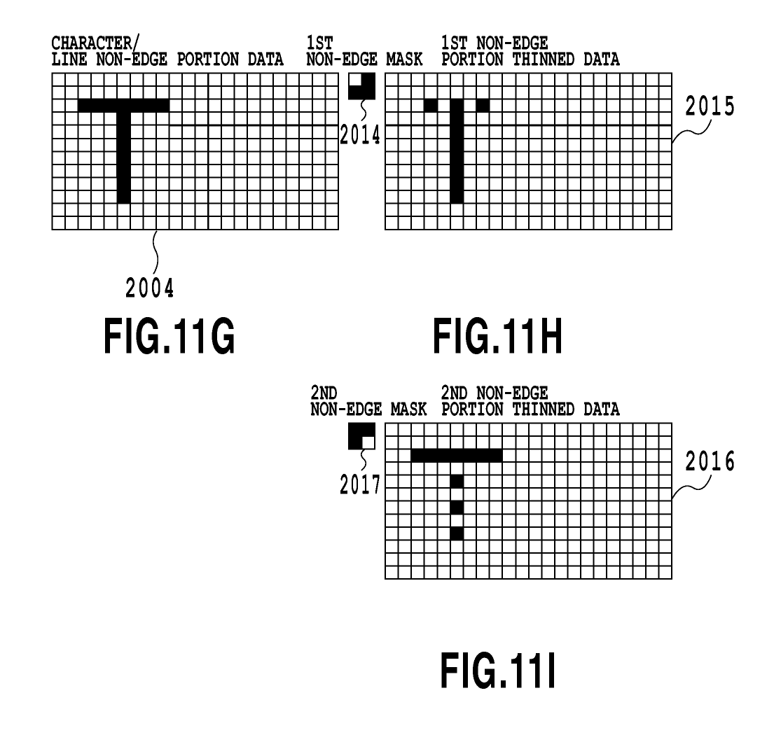

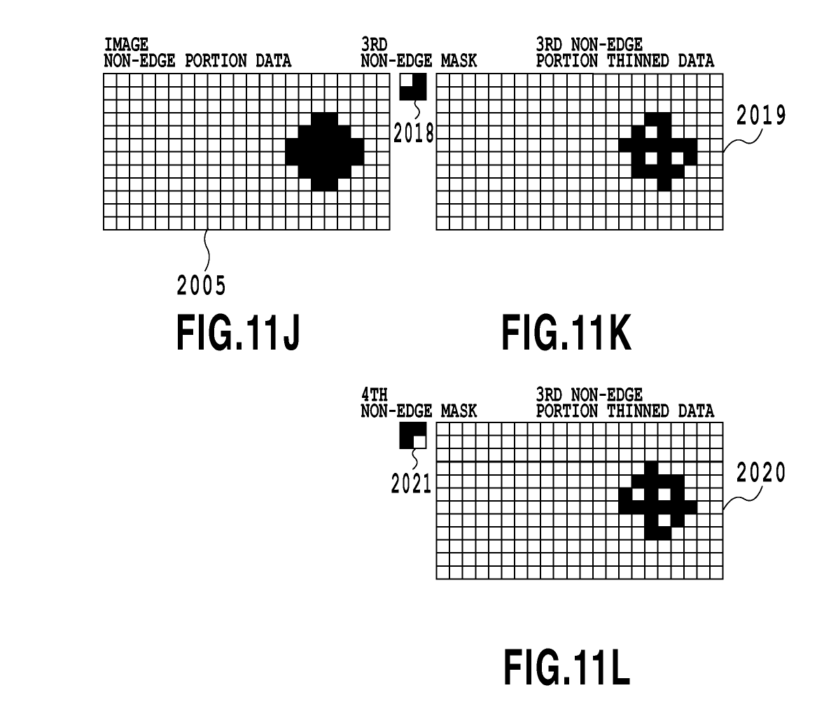

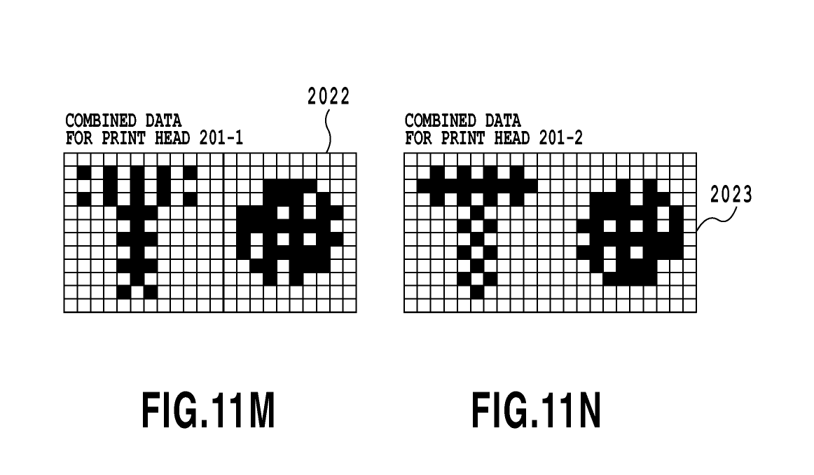

Next, the thinned first edge portion data 2007 and the thinned third edge portion data 2011 are combined (logical-ORed) with the thinned first non-edge portion data 2015 and the thinned third non-edge portion data 2019 to generate synthesized data 2022 for the print head 201-1, as shown in FIG. 11M (S107). Similarly, thinned second edge portion data 2008 and the thinned fourth edge portion data 2012 are combined (logical-ORed) with the thinned second non-edge portion data 2016 and the thinned fourth non-edge portion data 2020 to generate synthesized data 2023 for the print head 201-2, as shown in FIG. 11N (S108). After this the synthesized data 2022 for the print head 201-1 (2024) is transferred to the print head 201-1 and the synthesized data 2023 for the print head 201-2 (2025) is transferred to the print head 201-2 for printing.

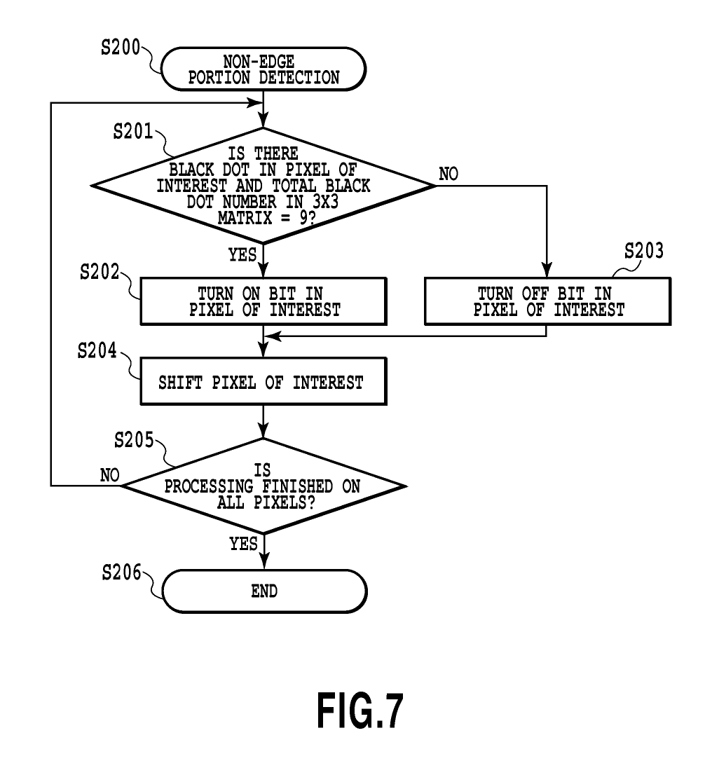

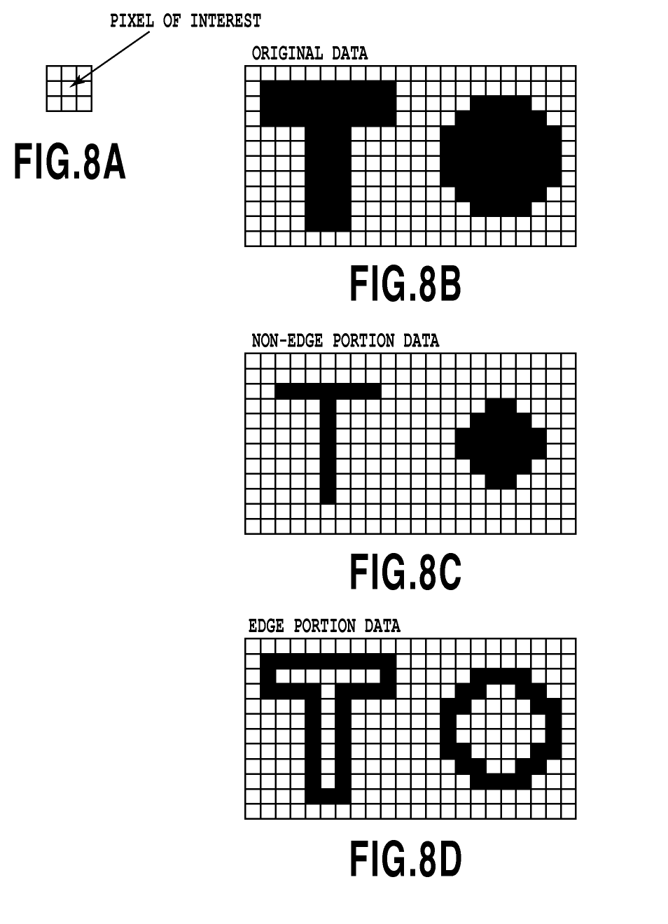

FIG. 7 is a flow chart showing a sequence of steps executed by 2000 of FIG. 5 and S101 of FIG. 6 to detect non-edge portions of print data. A check is made as to whether there is a black dot in a pixel of interest and whether the number of black dots in a 3×3 matrix (see FIG. 8A) centering on the pixel of interest (hereinafter referred to as a total black dot number) is 9 (S201). If the total black dot number is 9, the bit in the pixel of interest is turned on (to black) (S202). If not, the bit in the pixel of interest is turned off (to white) (S203). Then, the pixel of interest of the print data is shifted by one pixel (S204). This process is repeated and it is checked if the detection operation has been performed on all pixels of the print data (S205). If it is found that all the pixels have been processed, the non-edge portion detection operation on the print data is ended (S206). If not, the above process is continued.

FIG. 8A to FIG. 8D schematically illustrate the non-edge portion detection operation described above. FIG. 8A shows image data in a 3×3 matrix centering on the pixel of interest. FIG. 8B represents original image data (input image data). The non-edge portion detection operation is performed on the original image data by shifting the 3×3 matrix by one pixel at a time. Turning on a bit in the pixel of interest (to black) if the total black dot number in the matrix is 9 results in non-edge portion data being formed as shown in FIG. 8C.

The non-edge portion data thus generated is subtracted from the original print data, or the non-edge portion data and the original print data is Exclusive-ORed, to generate edge portion data as shown in FIG. 8D. Here, the edge portion is taken as being composed of one-pixel outline area while the non-edge portion is detected as being other than the outline 1-pixel area. It is noted, however, that these portions may be defined otherwise and that the edge portion may be detected as being an area of multiple pixels.

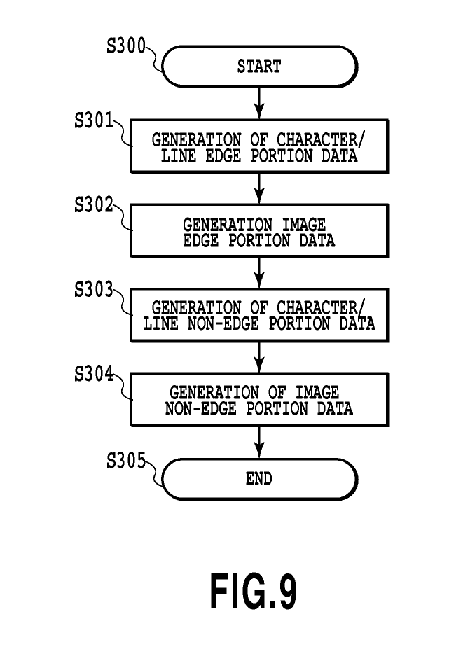

FIG. 9 is a flow chart showing a sequence of steps executed by an edge/non-edge portion data generation operation for each object of print data (2001 of FIG. 5 and S102 of FIG. 6) in the first embodiment. First, based on the character/line bold data 1017 and the edge portion data generated by the edge/non-edge portion detection operation 2000, character/line edge portion data 2002 is generated (S301). Next, based on the image bold data 1018 and edge portion data, image edge portion data 2003 is generated (S302). Similarly, from the character/line bold data 1017 and the non-edge portion data generated by the edge/non-edge portion detection operation 2000, character/line non-edge portion data 2004 is generated (S303). As a final step, from the image bold data 1018 and the non-edge portion data, image non-edge portion data 2005 is generated (S304). Then, the processing in the flow chart of FIG. 9 is ended.

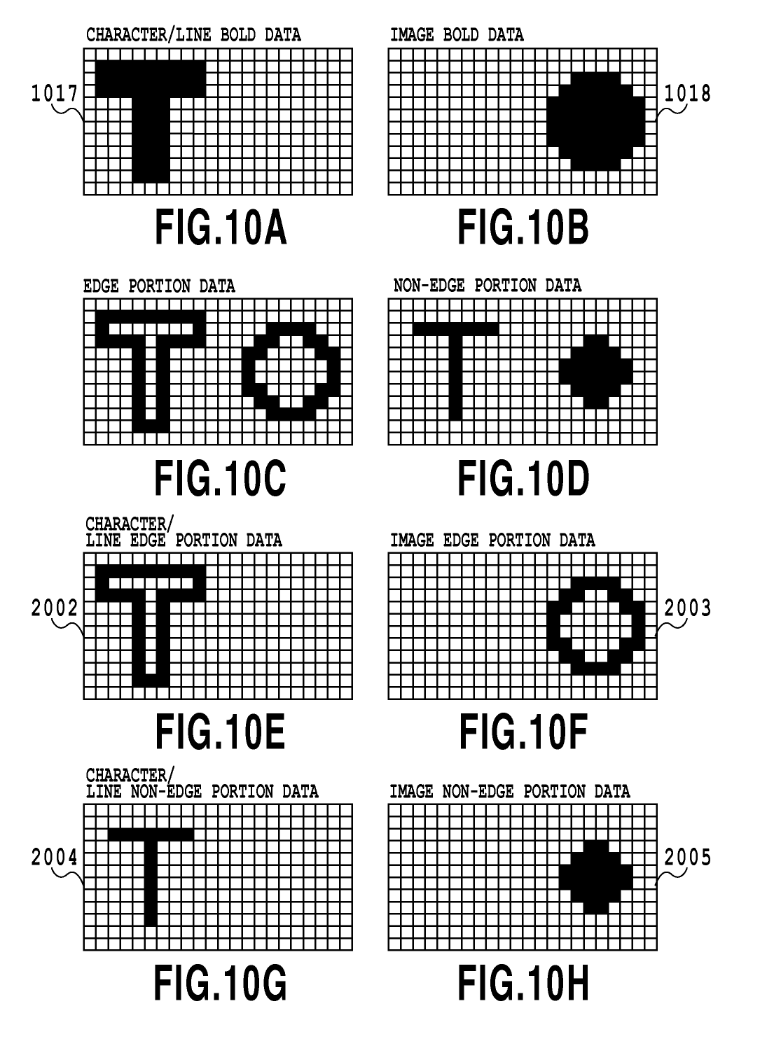

FIG. 10A to FIG. 10H schematically illustrate an example of the object-based edge/non-edge portion data generation operation of FIG. 9. FIG. 10A represents character/line bold data 1017 and FIG. 10B image bold data 1018. FIG. 10C represents edge portion data and FIG. 10D non-edge portion data.

The character/line bold data of FIG. 10A and the edge portion data of FIG. 10C are logically ANDed to eliminate the image edge data from the edge portion data of FIG. 10C, generating character/line edge portion data 2002 of FIG. 10E. Next, the image bold data of FIG. 10B and the edge portion data of FIG. 10C are logically ANDed to eliminate the character/line edge data from the edge portion data of FIG. 10C, thus generating image edge portion data 2003 of FIG. 10F.

Next, the character/line bold data of FIG. 10A and the non-edge portion data of FIG. 10D are logically ANDed to eliminate image data from the non-edge portion data of FIG. 10D, generating character/line non-edge portion data 2004 of FIG. 10G. Next, the image bold data of FIG. 10B and the non-edge portion data of FIG. 10D are logically ANDed to eliminate the character/line edge data from the non-edge portion data of FIG. 10D, generating image non-edge portion data 2005 of FIG. 10H.

FIG. 11A to FIG. 11N schematically illustrate the edge/non-edge portion data thinning operation (S103-S106 of FIG. 6) and the data generation operation for each print head (S107-S108 of FIG. 6) in this embodiment. The character/line edge portion data 2002 of FIG. 11A and a first edge mask 2006 with a print possibility ratio of 50% (thinning ratio of 50%) are logical-ANDed to generate thinned first edge portion data of FIG. 11B. Here, the first edge mask 2006 is supposed to repetitively perform a logical-AND operation on print data by taking a 2×2 pixel matrix as a unit.

Here, let us explain the print possibility ratio and the thinning ratio of a thinning mask. As shown in FIG. 11, thinning masks 2006, 2009, 2010, 2013, 2014, 2017, 2018 and 2021 are each made up of non-print-permitted s shown in black and non-print-permitted pixels shown in white. The “print-permitted pixels” are those at which ink ejection (dot printing) is permitted while “non-print-permitted pixels” are those at which the dot printing is not allowed. The “print possibility ratio” of the thinning mask is a ratio, in percentage, of the number of print-permitted pixels to the total number of pixels (all of the print permitted pixels and non-permitted pixels of the thinning mask). The “thinning ratio” of the mask, on the other hand, refers to a percentage of those binary data that can be eliminated in the thinning operation and is expressed in “100—print possibility ratio (%)”.

Next, the character/line edge portion data and the second edge mask 2009 with a print possibility ratio of 50% are logically ANDed to generate thinned second edge portion data 2008 shown in FIG. 11C. The first edge mask 2006 and the second edge mask 2009 are in a complementary relationship so that the character/line edge portion printed by the print data produced by the two masks has a maximum print duty of 50%×2=100%.

Another logical-AND is taken between the image edge portion data 2003 of FIG. 11D and the third edge mask 2010 with a print possibility ratio of 75% (thinning ratio of 25%) to generate thinned third edge portion data 2011 of FIG. 11E. Similarly, the image edge portion data 2003 of FIG. 11D and the fourth edge mask 2013 with a print possibility ratio of 75% (thinning ratio of 25%) are logically ANDed to generate thinned fourth edge portion data 2012 of FIG. 11F. The third edge mask 2010 and the fourth edge mask 2013 both allow upper left and lower right corners of the 2×2 matrix to be printed with a dot. Therefore, an image edge portion formed by the thinned third edge portion data 2011 and the thinned fourth edge portion data 2012 has a maximum print duty of 75%×2=150%.

Another logical-AND is taken between the character/line non-edge portion data 2004 of FIG. 11G and the first non-edge mask 2014 with a print possibility ratio of 75% (thinning ratio of 25%) to generate thinned first non-edge portion data 2015 of FIG. 11H. Similarly, the character/line non-edge portion data 2004 and the second non-edge mask 2017 are logically ANDed to generate thinned second non-edge portion data 2016 of FIG. 11I. The first non-edge mask 2014 and the second non-edge mask 2017 both allow upper right and lower left corners of the 2×2 matrix to be printed with a dot. Therefore, a character/line non-edge portion formed by the thinned first non-edge portion data 2015 and the thinned second non-edge portion data 2016 has a maximum print duty of 75%×2=150%.

Still another logical-AND is taken between the image non-edge portion data 2005 of FIG. 11J and the third non-edge mask 2018 with a print possibility ratio of 75% (thinning ratio of 25%) to generate third non-edge portion thinned data 2019 of FIG. 11K. Similarly, the image non-edge portion data 2005 and the fourth non-edge mask 2021 are logically ANDed to generate fourth non-edge portion thinned data 2020 of FIG. 11L. The third non-edge mask 2018 and the fourth non-edge mask 2021 both allow upper right and lower left corners of the 2×2 matrix to be printed with a dot. Therefore, a character/line non-edge portion formed by the third non-edge portion thinned data 2019 and the fourth non-edge portion thinned data 2020 has a maximum print duty of 75%×2=150%.

Next, the first edge portion thinned data 2007, the third edge portion thinned data 2011, the first non-edge portion thinned data 2015 and the third non-edge portion thinned data 2019 are logically ORed to generate synthesized data 2022 for the print head 201-1. Further, another logical-OR operation is performed among the second edge portion thinned data 2008, the fourth edge portion thinned data 2012, the second non-edge portion thinned data 2016 and the fourth non-edge portion thinned data 2020 to generate synthesized data 2023 for the print head 201-2.

Then, the synthesized data 2022 is transferred to the print head 201-1 and the synthesized data 2023 to the print head 201-2. As a result, the character/line edge portion has a maximum print duty of 100% while the image edge portion has a maximum print duty of 150%. The character/line non-edge portion has a maximum print duty of 150% while the image non-edge portion has a maximum print duty of 150%. Thus, in characters and lines the print duty of edge portions can be kept at an appropriate level, reducing the possibility of characters spreading and bleeding due to over-ejection of ink, forming highly defined characters and line images. Also in relatively large characters and lines, since the percentage of non-edge portions with high print duty increases, it is possible to form characters and lines with high grayscale levels while keeping the grayscale level of edge portions at a moderate level to prevent the character/line bleeding. Further, in images, since they are printed at a print duty of up to 150% whether they are edge portions or non-edge portions, high-quality images with high grayscale levels can be formed.

In the first embodiment described above, edge/non-edge portions are detected for each object and the maximum print duties for edge/non-edge portions are changed for each object. This allows high-quality images to be printed at high grayscale levels while maintaining high resolution.

Further, in the first embodiment described above, although objects of characters and lines are treated the same way, they may be regarded as different objects and given different treatments. While the first embodiment sets the maximum print duty of the character/line edge portions at 100% and those of other portions at 150%, the value of the maximum print duty may be set otherwise. It is preferred that the maximum print duty be set at an optimum value according to the kind of ink and of media used. Sharpness and grayscale level required of characters and lines differ also according to uses of the printed matters. Therefore, the duties of edge/non-edge portions should preferably be set at optimum values for each object according to uses of printed matters.

Further, although in the first embodiment the maximum print duty of the non-edge portions is set higher than that of the edge portions, other setting may be used. When one wishes to give priority to a fixing performance while maintaining the sharpness of characters/lines, the maximum print duty of non-edge portions may be set lower than that of edge portions.

Although the first embodiment has taken up an example case of printing a single color ink, i.e., black, the same processing may also be performed for other colors (e.g., cyan, magenta and yellow) in printing color images.

### Second Embodiment

Next, a second embodiment of this invention will be described. In the first embodiment edge/non-edge portions are detected for each object (attribute information) contained in input image data. In the second embodiment, however, the edge/non-edge portion detection is performed separately for an image composed of pixels having a predetermined RGB value and for an image composed of other pixels, and then the maximum print duties of edge/non-edge portions are changed. This allows an optimum printing in terms of sharpness and grayscale level to be performed.

With this embodiment, even when image attribute information (object information) of characters, lines and images is not available, the grayscale level can be controlled separately for edge portions of an image with a specified color and for other portions. The second embodiment also has the construction shown in FIG. 1 to FIG. 4 used by the first embodiment.

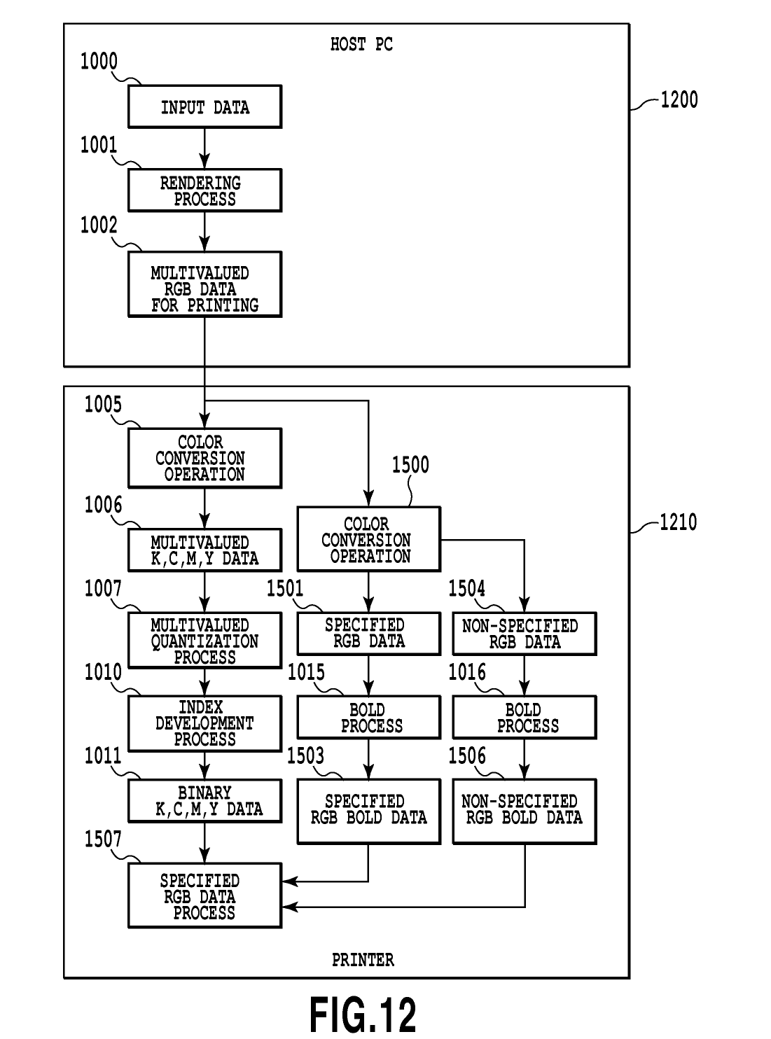

FIG. 12 is a functional block diagram showing an operation to convert input image data into print data that can be printed by the ink jet printing apparatus of the second embodiment.

A host PC 1200 performs a 600-dpi rendering process 1001 on input RGB data (input image data) 1000 received from an application to generate multivalued RGB data 1002 (in this embodiment 256-value RGB data) for printing. The multivalued RGB data 1002 thus generated is transferred to the printer 1210, which performs a color conversion process 1010 to convert the multivalued RGB data into multivalued KCMY data. The converted KCMY data 1011 is subjected to a quantization process by a predetermined method. In this embodiment the KCMY data is quantized into 5-value data with a resolution of 600 dpi by an error diffusion method. The quantized KCMY data is index-developed at 1013 to generate 1200-dpi binary data 1014 that can be printed by the print head.

In the printer 12010, the multivalued RGB data 1002 for printing is subjected to a specified RGB value detection operation to generate specified RGB value data 1501 and non-specified RGB value data 1504. The specified RGB value data 1501 is further subjected to a bold process 1015 to match it with the resolution of the printer 1210, generating specified RGB bold data 1503. This bold process is done to match the resolution of 600 dpi to that of 1200 dpi. Similarly, non-specified RGB value data 1504, or data other than the specified RGB value, is also subjected to a bold process 1016 for matching with the resolution of the print data, generating non-specified RGB bold data 1506. As a final step, based on the index-developed binary data 1014, the specified RGB bold data 1503 and the non-specified RGB bold data 1506, specified RGB value data processing 1507 is performed.

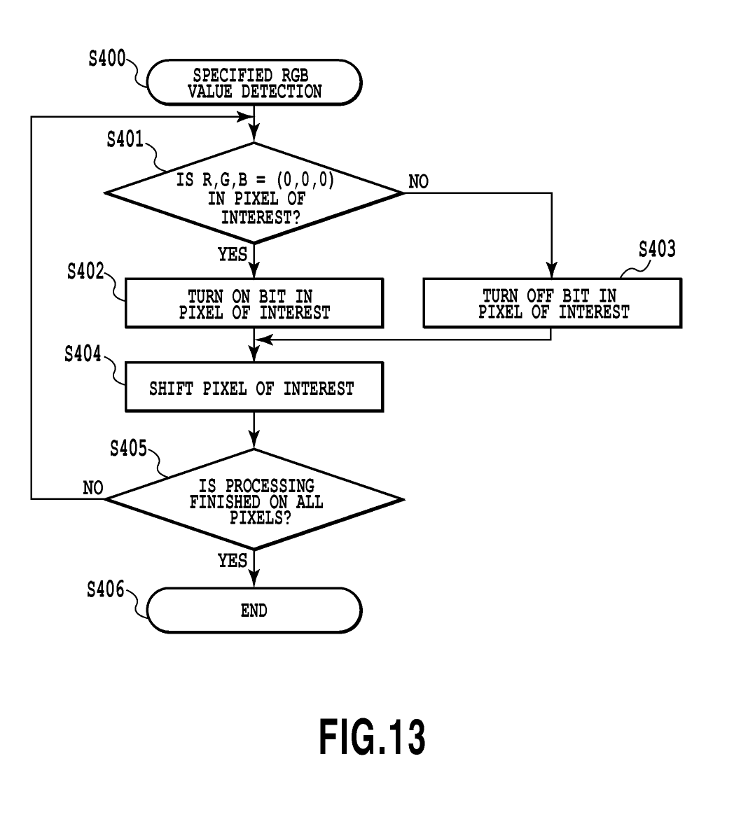

FIG. 13 is a flow chart showing a sequence of steps in a specified RGB value detection operation 1500 for print data in the second embodiment of this invention. Here, we take up an example case of detecting pixels with R, G, B=(0, 0, 0) (black pixels). Pixels with R=G=B=0 are those making up black letters, and detecting many of them can determine the presence of black letters in the image.

First, a check is made as to whether R, G, B of a pixel of interest are R, G, B=(0, 0, 0) (S401). If so, a bit in the pixel of interest is turned on (to black) (S402). If not, the bit of the pixel is turned off (to white) (S403). Then, the pixel of interest in the print data is shifted by one pixel (S404). This operation is repeated until the detection is finished for all pixels of the print data, at which time the specified RGB value detection operation for print data is ended (S405). If the detection is not finished, the above steps S401-S404 are repeated.

Then the specified RGB value data 1501 is inverted to generate the non-specified RGB value data 1504.

While in the second embodiment the image data processing has been described to be divided between the host PC 1200 and the printer 1210, the present invention is not limited to this configuration and the only requirement is to share the operational burden optimally according to the configuration of the print system.

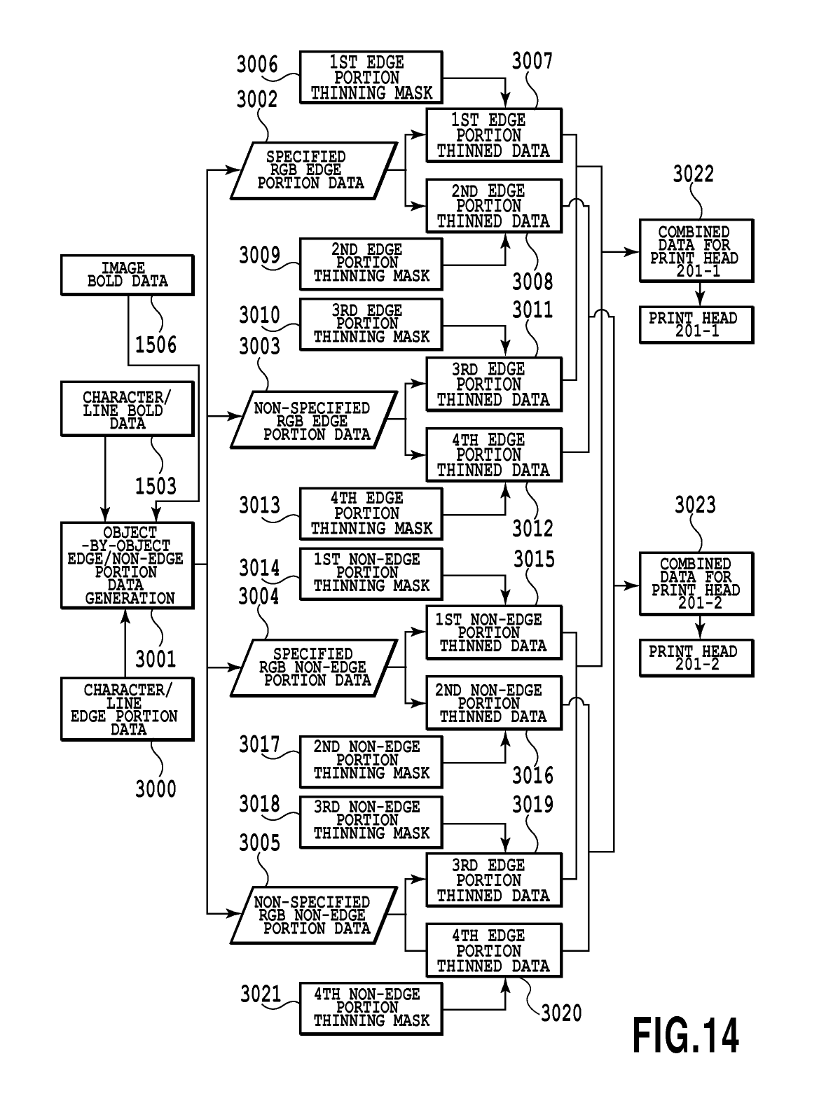

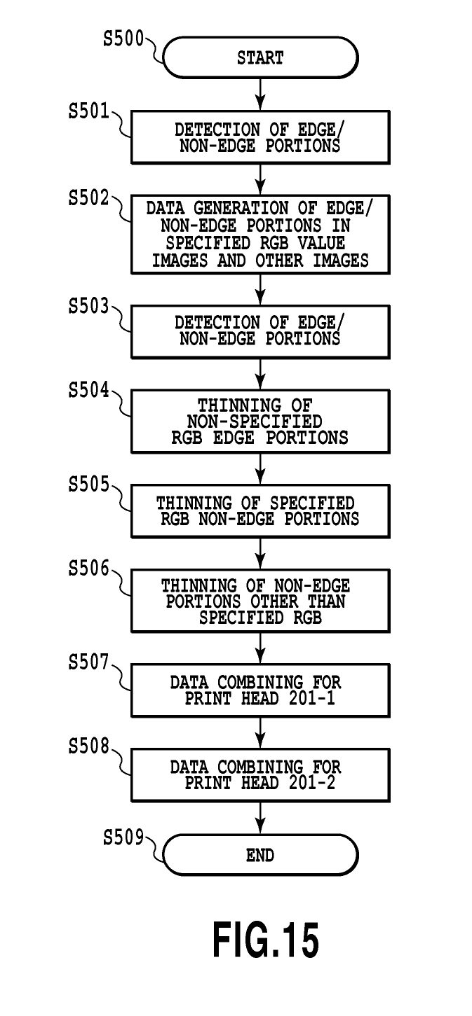

FIG. 14 is a block diagram showing an overall function of the specified RGB value data processing 1507 in the second embodiment. FIG. 15 is a flow chart showing a sequence of steps executed by the data generation operation of the second embodiment.

The operations shown in FIG. 14 and FIG. 15 use the specified RGB bold data 1503 and the non-specified RGB bold data 1506 instead of the character/line bold data 1017 and image bold data 1018 of the first embodiment. The basic processing other than this is similar to that of the first embodiment. That is, for the specified RGB value image and for the other image, the edge/non-edge portions are detected (S501, 502). Next, by using thinning masks 3006, 3009, edge portion data 3002 of the specified RGB value image is subjected to a thinning operation (S503). Then, by using thinning masks 3010, 3013, edge portion data 3003 of the non-specified RGB value image is subjected to a thinning operation (S504). Next, a thinning operation is performed on non-edge portion data 3004 of the specified RGB value image by using thinning masks 3014, 3017 (S505). Then, non-edge portion data 3005 of the non-specified RGB value image is subjected to a thinning operation using thinning mask 3018, 3021 (S506). It is noted that the thinning masks 3006, 3009 shown in FIG. 14 have a print possibility ratio of 50% (thinning ratio of 50%), as with the edge masks 2006, 2009 of FIG. 11B and FIG. 11C. The other thinning masks 3010, 3013, 3014 3017, 3018, 3021 shown in FIG. 14 are the same as the edge masks 2010, 2013, 2014, 2017, 2018, 2021 shown in FIGS. 11E, 11F, 11H, 11I, 11K, 11L and have a print possibility ratio of 75% (thinning ratio of 25%). Of the print data thinned by the thinning masks, the print data 3007, 3011 3015, 3019 are combined and transferred to the print head 201-1 and the print data 3008, 3012, 3016, 3020 are combined and transferred to the print head 201-2.

As a result, the print duty of the edge portions of the specified RGB value image is 100% at maximum and that of the edge portions of the non-specified RGB value image is 150% at maximum. For the non-edge portions of the specified RGB value image, the print duty is 150% at maximum; and for non-edge portions of the non-specified RGB value image, the print duty is 150% at maximum. Therefore, in the specified RGB value image the print duty of edge portions can be kept at an appropriate level, reducing the possibility of the edge portions spreading and bleeding, while at the same time enhancing the grayscale level of the non-edge portions to form sharp and vivid images. Further, in the non-specified RGB value image, since the printing is performed at a print duty of up to 150% whether they are edge portions or non-edge portions, high-quality images with high grayscale levels can be formed.

As described above, with the second embodiment, it is possible to detect edge and non-edge portions in a specified RGB value image and also in a non-specified RGB value image and change the maximum print duties of the edge portions and the non-edge portions in the printing operation. As a result, even in input image data whose object information is not available, such as bit-map image data, it is possible to selectively control the grayscale level of data, such as black characters, embedded in the image, allowing for high-quality printing at high grayscale level while maintaining sharpness of black characters.

While the second embodiment has been described to specify R, G, B=(0, 0, 0) as a specified RGB value, other values or ranges may be used. For example, an image with an RGB value range of R, G, B=(0, 0, 0) to R, G, B=(32, 32, 32) may be taken as the specified RGB value image and the maximum print duty may be differentiated between the specified RGB value image and other images.

Further, while the second embodiment has taken for example a case of printing a single color ink, i.e., black, the same processing may also be performed also for other colors (e.g., cyan, magenta and yellow) to produce the same effect as when a black image is printed.

### Third Embodiment

Next, a third embodiment of this invention will be explained.

The third embodiment of this invention performs a data thinning operation that thins surrounding black and color image data according to character object information and specified RGB data. This suppresses bleeding (or spreading) that occurs at a boundary between an ink forming characters and specified RGB value image and an ink forming surrounding background.

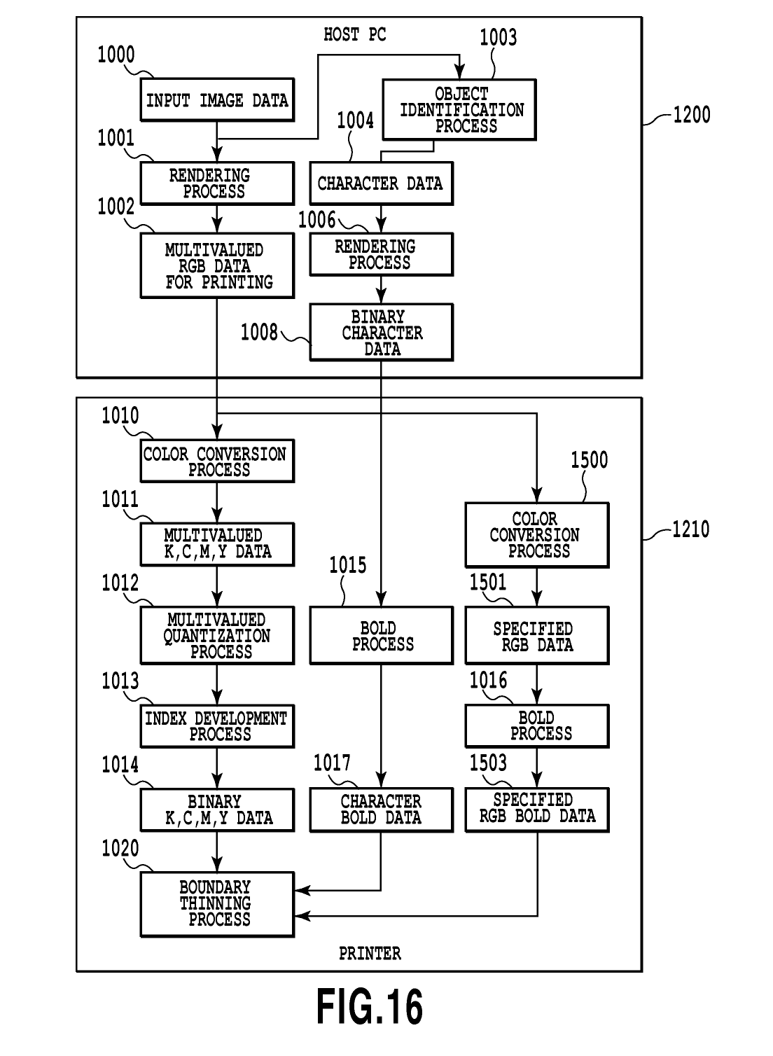

FIG. 16 is a functional block diagram showing a data conversion operation for converting input image data into print data that can be printed by the ink jet printing apparatus. A host PC 1200 performs a 600-dpi rendering process 1001 on input RGB data 1000 received from an application, generating multivalued (in this embodiment, 256-value) RGB data 1002 for printing. Based on the input RGB data 1000, an object identification process 1003 is executed. The character data that has been identified as characters by the object identification process 1003 is subjected to a rendering process 1006 to generate 600-dpi binary character data 1008. The multivalued RGB data 1002 and the binary character data 1008 are transferred to the printer 1210.

The printer 1210 in a conversion operation 1010 converts multivalued RGB data into multivalued KCMY data 1011. The converted multivalued KCMY data 1011 is subjected to a quantization process 1012 based on a predetermined quantization method. In this embodiment, the KCMY data is quantized by an error diffusion method into 600-dpi 5-value data. The quantized KCMY data is then index-developed by an index development process 1013 into 1200-dpi binary KCMY data 1014 that can be printed by the print heads. This index development process 1013 uses matrix-like dot arrangement data corresponding to each of the five values and outputs a dot matrix pattern according to the 5-value data. In this embodiment, the 5-value data is developed into a 2×2 dot matrix.

The binary character data 1008 is subjected to a bold process 1015 to match it with the resolution of the printer 1210, generating character bold data 1017. This bold process is done to match the resolution of 600 dpi to that of 1200 dpi.

The printer 1210, as in the second embodiment, performs the specified RGB value detection operation on the multivalued RGB data 1002 for printing to generate specified RGB value data 1501. The specified RGB value data 1501 is subjected to a bold process 1016 that matches it with the resolution of the printer 1210 and thereby generates specified RGB bold data 1503. As a final step, a boundary thinning process 1020 is executed based on the index-developed binary KCMY data 1014, the character bold data 1017 and the specified RGB bold data 1503.

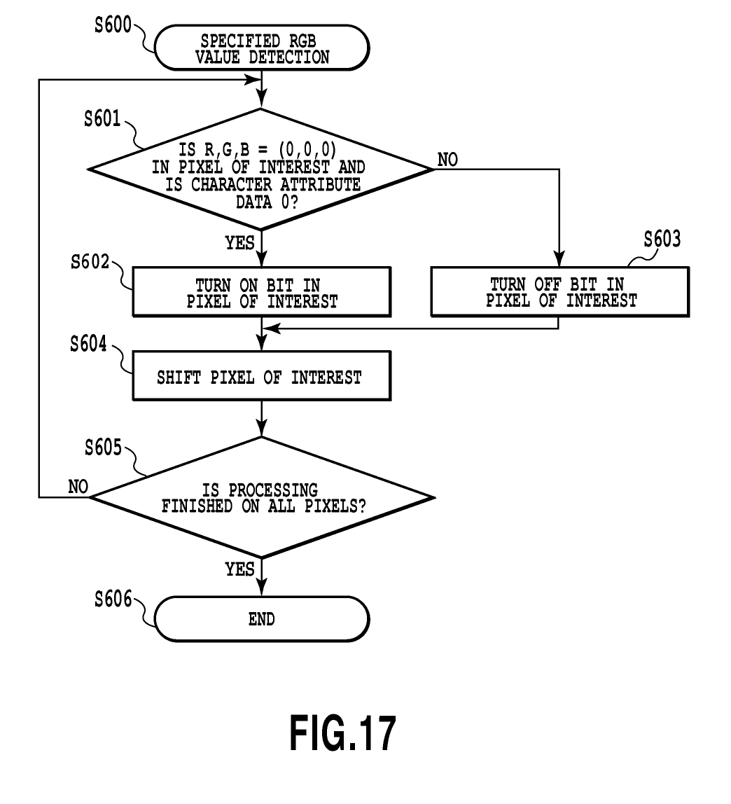

FIG. 17 is a flow chart showing a sequence of steps executed by the specified RGB value print data detection operation of the third embodiment. Here, the detection operation is explained for an example case in which pixels (black pixels) with R, G, B=(0, 0, 0) are to be detected.

First, a check is made as to whether, of print data, a pixel of interest has R, G, B values of (0, 0, 0) and whether the value of character data of that pixel is 0 (off) (S601). If the R, G, B values of the pixel of interest are not (0, 0, 0) and the value of character data is not 0, a bit in the pixel of interest is turned on (to black) (S602). If not, the bit in that pixel is turned off (to white) (S603). Then, the pixel of interest in the print data is shifted by one pixel (S604). This operation is repeated until the detection operation is performed on all pixels of the print data, at which time the specified RGB value print data detection operation is ended (S605). If the operation is not complete on all pixels, the above operation is repeated. S602 turns on the bit of the pixel of interest only when the data of character attribute data is 0. This ensures that the character data and the specified RGB data will not be turned on overlappingly for the same pixel. This prevents a similar thinning operation from being performed again at a later stage.

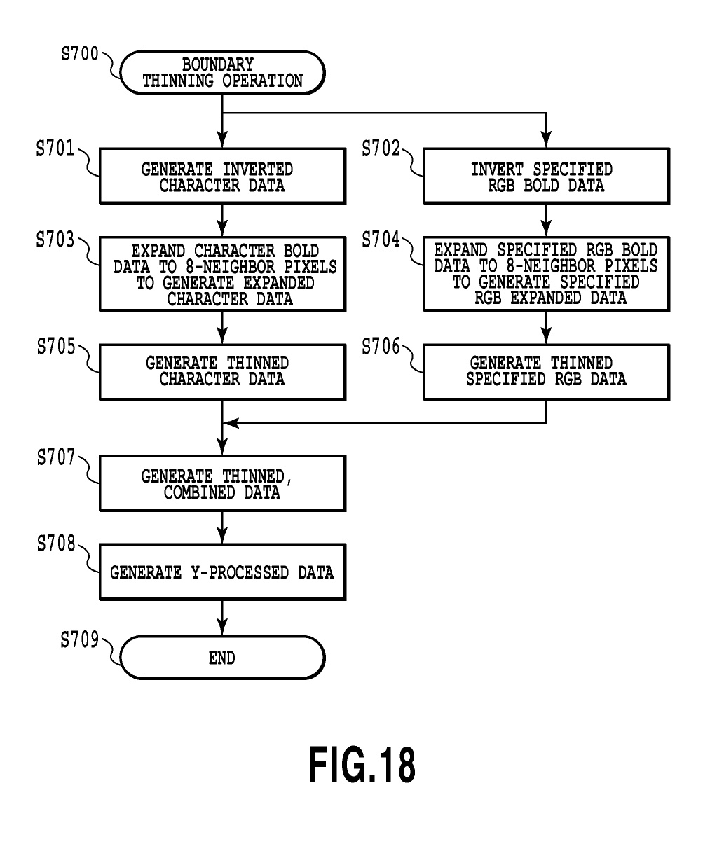

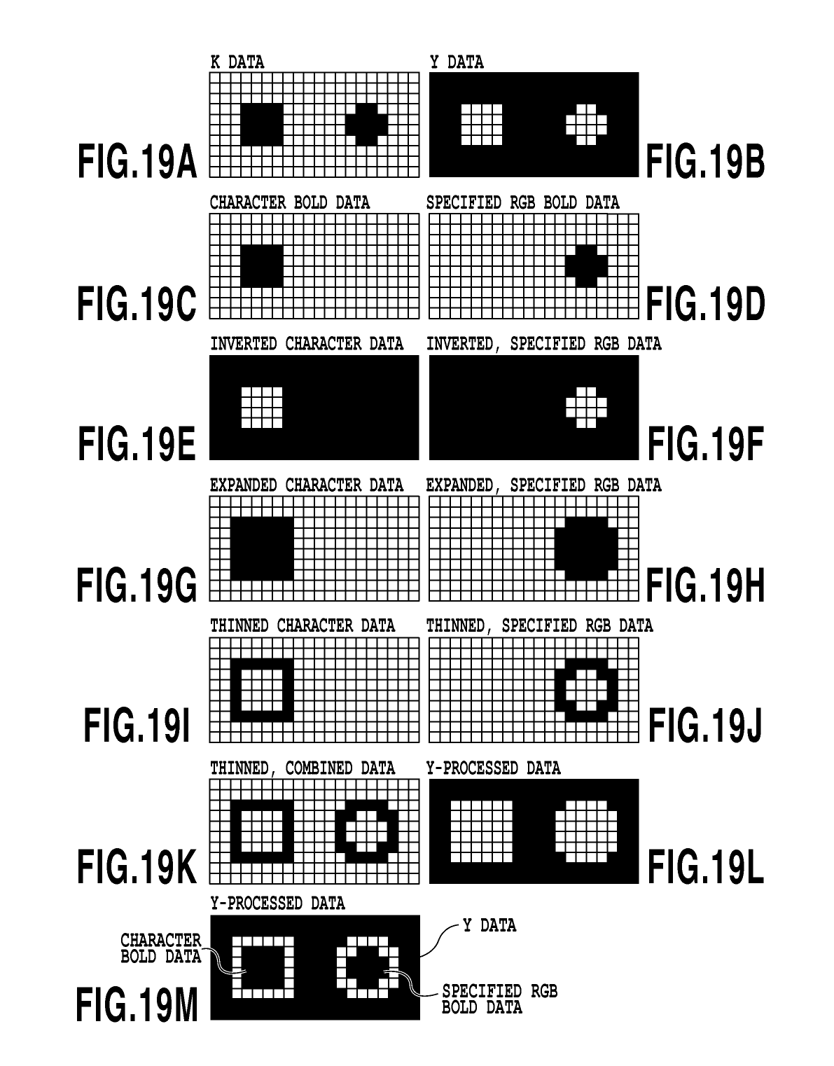

FIG. 18 is a flow chart showing a sequence of steps executed by a boundary thinning process of the third embodiment. FIG. 19A to FIG. 19M illustrate image data generated by each of the steps of the boundary thinning process. In the following explanation, simple images such as shown in FIG. 19A and FIG. 19B are represented as character or specified RGB value image data. Here, FIG. 19A illustrates black image data (K data) and FIG. 19B illustrates yellow image data (Y data). A thinning operation that is performed on a boundary portion between adjoining K data and Y data will be described as an example case.

Once this process is started (S700), the character bold data 1017 of FIG. 19C is inverted to generate inverted character data shown in FIG. 19E (S701). Similarly, the specified RGB bold data 1503 of FIG. 19D is inverted to generate inverted specified RGB data shown in FIG. 19F (S702).

Next, the character bold data 1017 of FIG. 19C is expanded to eight-neighbor pixels to generate expanded character data shown in FIG. 19G (S703). Similarly the specified RGB bold data 1503 of FIG. 19D is expanded to eight-neighbor pixels to generate expanded specified RGB data shown in FIG. 19H (S704).

Next, inverted character data of FIG. 19E is logically ANDed with the expanded character data of FIG. 19G to generate thinned character data (S705). Similarly, the inverted specified RGB data of FIG. 19F is logically ANDed with the expanded specified RGB data of FIG. 19H to generate thinned specified RGB data shown in FIG. 19J (S706).

Next, the thinned character data of FIG. 19I and the thinned specified RGB data of FIG. 19J are logically ORed to generate combined thinned data shown in FIG. 19K (S707). After this, the combined thinned data of FIG. 19K is inverted and logically ANDed with Y image data of FIG. 19B to obtain yellow image data to be printed or Y-processed data shown in FIG. 19L. The process of FIG. 19 is then ended. The Y-processed data is image data obtained by thinning with a thinning ratio of 100% those pixels of the Y image data of FIG. 19B that are situated at 8-neighbor positions adjacent to the character and specified RGB data of FIG. 19A. In other words, it is image data that has undergone the boundary thinning process. That is, by printing the character and specified RGB data of FIG. 19A and the Y-processed data of FIG. 19L, an image of FIG. 19M is formed, with 1-pixel-wide areas surrounding the character and specified RGB image left unprinted. This process can therefore prevent a bleeding from occurring at a boundary between an ink forming the character and specified RGB image and an ink forming the Y image constituting the surrounding background. Thus, with the third embodiment, it is possible to produce high-resolution, well-defined images of characters and lines and of the specified RGB images.

In the above third embodiment, the processing shown in FIG. 18 can also be executed among K, C, M and Y data in the similar way to generate boundary-thinned K, C, M and Y data. At this time, it is also possible to perform the boundary thinning process on all K, C, M and Y characters whereas, for the specified RGB data, the thinning operation is performed only on the C, M and Y data but not on K data. Since the likelihood of occurrence of bleeding varies according to the ink and print material used, if there are inks that do not easily bleed, the thinning operation may be done by selecting image data of only those inks which easily bleed.

Further, although in the third embodiment the 8-neighbor pixels adjoining an image of interest, such as character and specified RGB image, are thinned at a thinning ratio of 100%, the thinning ratio (print possibility ratio) may be set according to the likelihood of ink bleeding occurrence. For example, a mask for thinning print data may be provided for each ink color and the thinning ratio for each mask may be set according the ink bleeding likelihood. Then, the thinning mask and the combined thinned data of FIG. 19K are logically ANDed to adjust the level of thinning.

While this embodiment performs the boundary thinning process based on character and specified RGB data, the thinning operation may also be performed on lines and other objects.

Further, although this embodiment uses R, G, B=(0, 0, 0) as a specified RGB value, other RGB value may be used. For example, the thinning operation may also be performed on a range of RGB value from R, G, B=(0, 0, 0) to R, G, B=(32, 32, 32).

As described above, with the third embodiment, for characters, the boundary thinning process is performed based on character data, thus reducing bleeding that would otherwise occur at a boundary between a character forming ink and a surrounding background forming ink. For specified RGB value images, the thinning operation is performed according to their RGB value image data, making it possible to thin data adjoining the specified RGB value images even in such image data as bit map images whose object information is not available. Therefore, even black characters embedded in images can be printed sharp at high resolution with no bleeding.

Although the above preceding embodiments perform the bold data generation operation based on input image data in order to match the input image data to the resolution of the printer, if the resolutions of the input image data and the printer are equal, the bold data generation operation is not required.

### Fourth Embodiment

Next, a fourth embodiment of this invention will be described. In addition to the detection of attributes such as characters, lines and images (object detection), the fourth embodiment also detects pixels in an image with a specified RGB value (e.g., black pixels with R=G=B=0). Further, a maximum print duty is differentiated between edge portions and other portions of characters/lines and of specified RGB value image (e.g., black characters) within an image. This allows for an optimal printing in terms of sharpness and grayscale level.

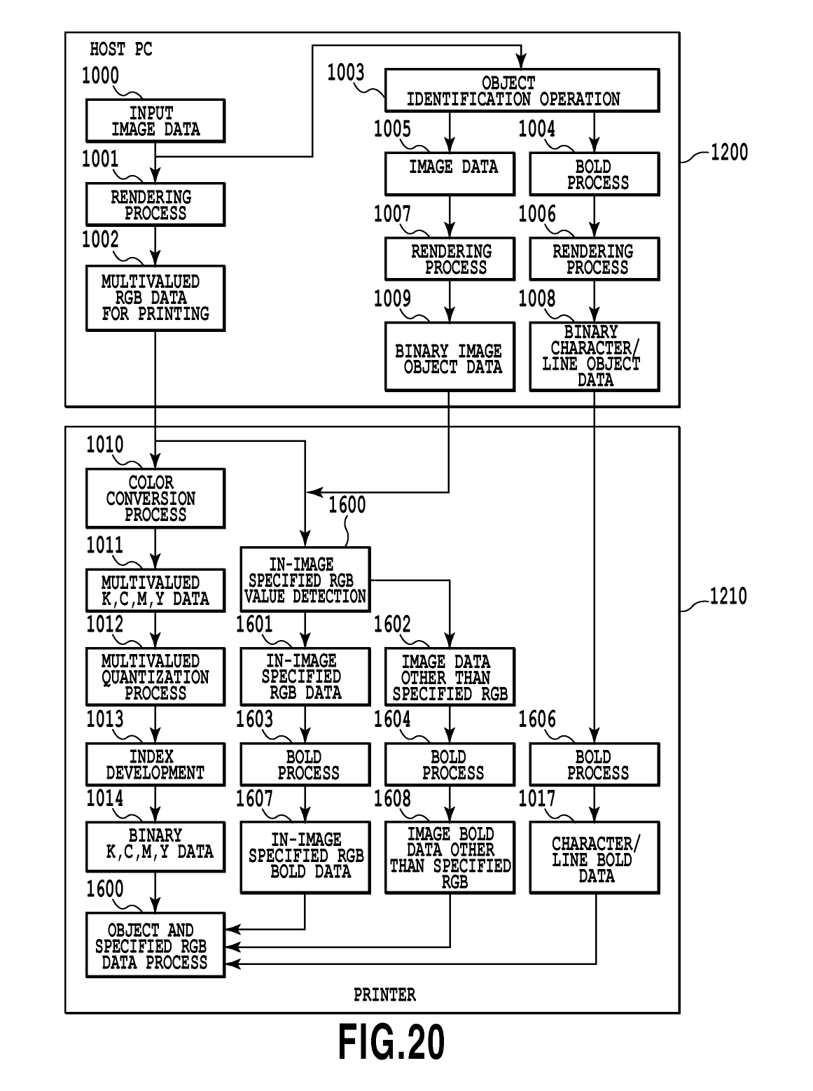

FIG. 20 is a functional block diagram showing a data conversion operation in the fourth embodiment that converts input image data into data that can be printed by the ink jet printing apparatus. A host PC 1200 first performs a 600-dpi rendering process 1001 on the input RGB data (input image data) 1000 received from an application to generate multivalued (in this embodiment, 256-value) RGB data 1002 for printing. Then, an operation to distinguish between character/line objects forming a plurality of kinds of image constitutional elements included in an image to be printed and image (e.g., bit map data) objects is performed according to the input image data 1000. This is followed by rendering process 1006, 1007 being performed on the character/line object data 1004 and the image object data 1005, respectively, thus generating binary character/line object data 1008 with a resolution of 600 dpi and binary image object data 1009. The multivalued RGB data 1002 and the binary object data 1008, 1009 thus generated are transferred to the printer 1210. At this time, all image data necessarily belongs to one of the character, line and image objects.

The printer 1210 performs a color conversion process 1010 to convert multivalued RGB data into multivalued KCMY data. The converted KCMY data 1011 is then subjected to a quantization process 1012 using a specified quantization method. In this embodiment, the quantization process is done by an error diffusion method to produce 600-dpi 5-value data. The quantized KCMY data is then index-developed at 1013 into 1200-dpi binary KCMY data 1014 that can be printed by the print head.

The printer 1210 on the other hand performs a detection operation on the multivalued RGB data 1002 and the binary image object data 1009 to find a predetermined RGB value (specified RGB value) included in the image. Here, pixels to be detected are those with R, G, B=(0, 0, 0) (black pixels). Detecting many pixels with R=G=B=0, which constitute black characters, can detect black characters present in the image. Then, specified RGB value data 1601 in an image and image data 1602 other than the specified RGB value are generated. The specified RGB value data in an image refers to specified RGB value data within a range of the RGB value that is obtained by performing a logical AND operation on the binary image object data 1009 and the multivalued RGB data 1002 for printing. The image data 1602 other than the specified RGB value refers to the specified RGB value data 1601 of the image subtracted from the binary image object data 1009. The specified RGB value data 1601 in the image is subjected to a bold process 1603 to match its resolution to that of the printer 1210 and thereby generate specified RGB value bold data 1607 in the image. This bold process is intended to match the resolution of 600 dpi to that of 1200 dpi. Similarly, the image data 1602 other than the specified RGB value data is also subjected to a bold process 1604 to match its resolution with the resolution of the print data, generating non-specified RGB image bold data 1608.

As a final step, object and specified RGB data process 1600 to be described later is performed based on the index-developed binary KCMY data 1014, the character bold data 1017, the specified RGB value bold data 1607 in an image and the image bold data 1608 other than the specified RGB data.

While in the fourth embodiment the image data processing is divided between the host PC and the printer 1210, this invention is not limited to this configuration. For example, the printer 1210 may perform all of the processing shown in FIG. 20. What is required is that the above image data processing be able to be executed in the ink jet printing system comprised of the host 1200 and the printer 1210.

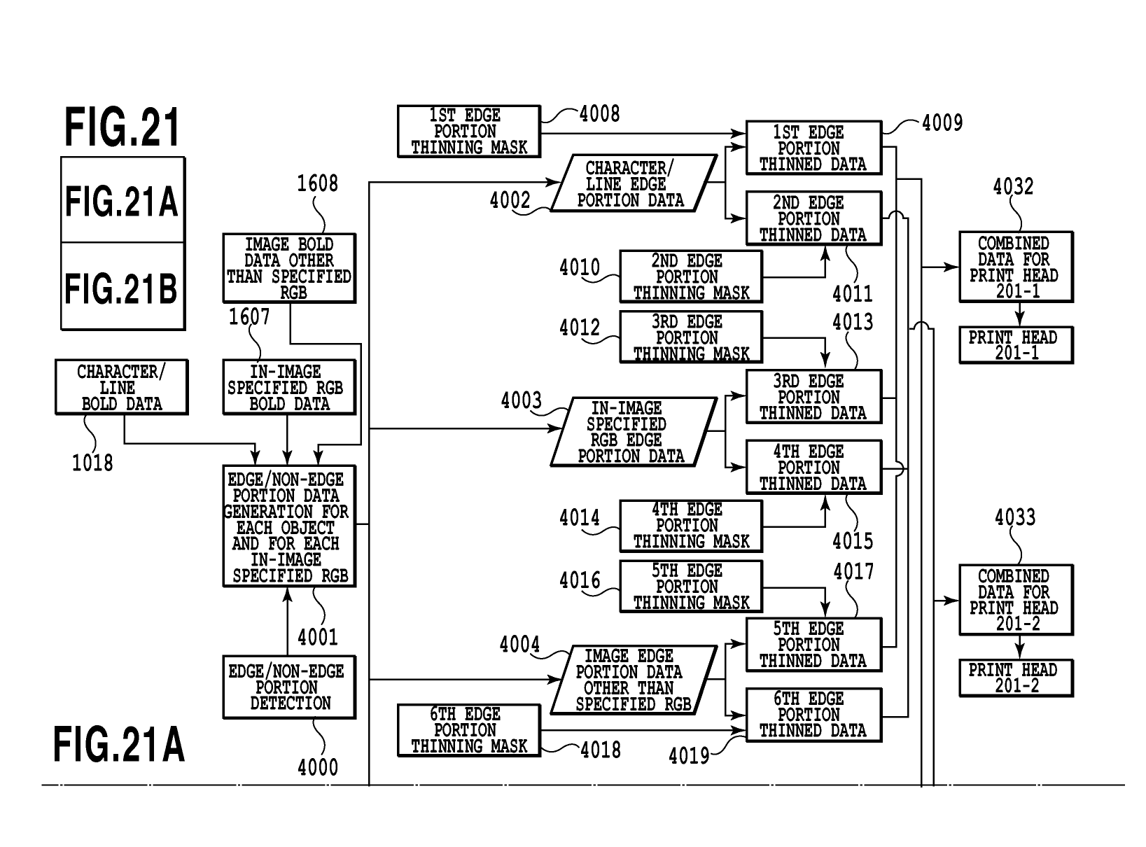

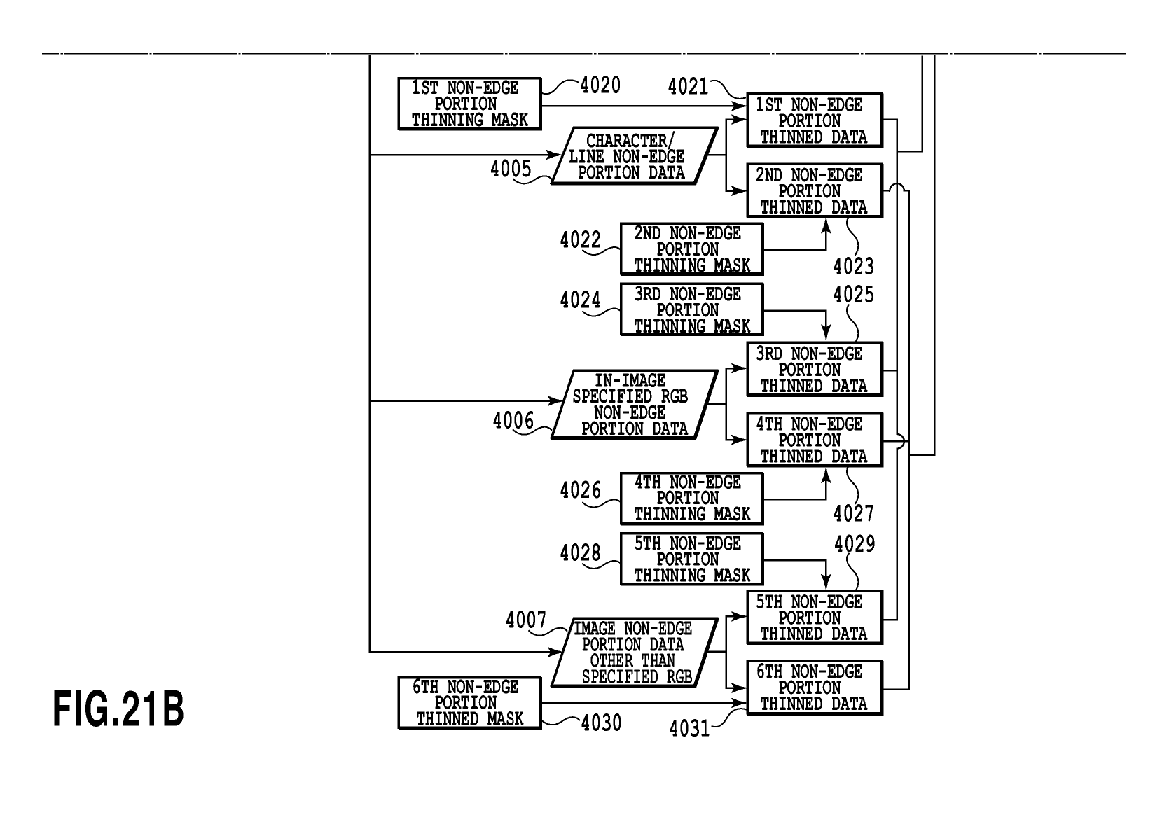

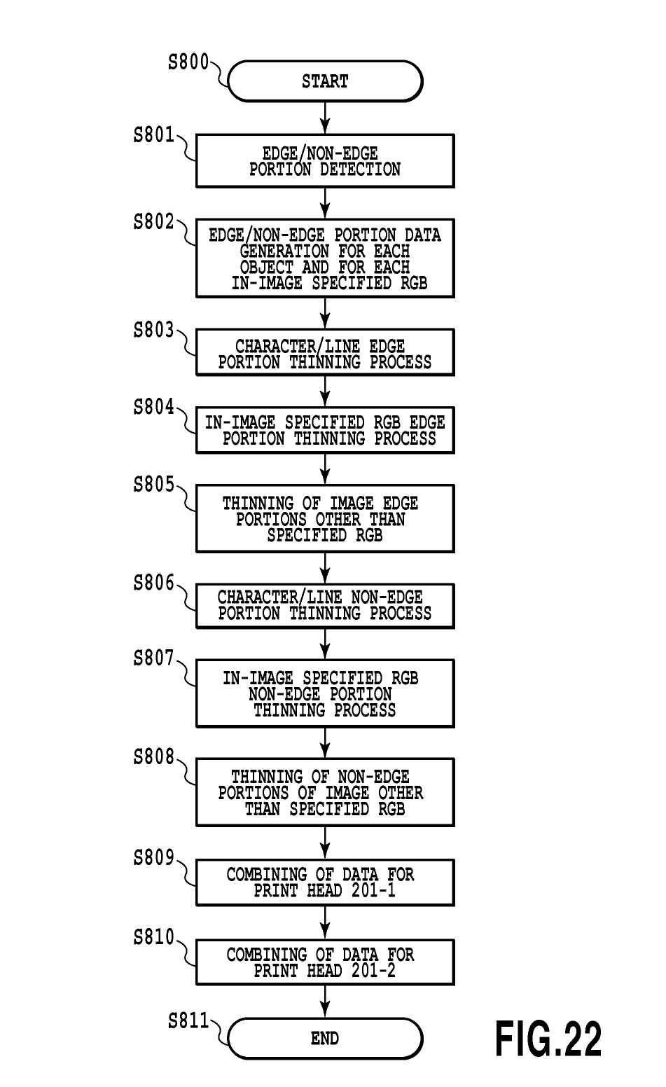

FIG. 21A, FIG. 21B and FIG. 22 are a block diagram and a flow chart of a data generation operation using the character/line bold data 1017, the specified RGB value bold data 1607 in an image and the image bold data 1608 other than the specified RGB data. The basic steps are the same as those of the first and second embodiment. First, for the character/line bold data 1017, the specified RGB value bold data 1607 in an image and the image bold data 1608, edge/non-edge portions are detected (S801, S802).

Next, character/line edge portion data 4002 is subjected to a thinning operation using thinning masks 4008, 4010 (S803). Masks 2006, 2009 of FIG. 11 with a print possibility ratio of 50% (thinning ratio of 50%) are used as the thinning masks 4008, 4010. Next, using thinning masks 4012, 4014 a thinning operation is performed on in-image specified RGB edge portion data 4003 (S804). As the thinning masks 4012, 4014, masks 2006, 2009 shown in FIG. 11 with a print possibility ratio of 50% (thinning ratio of 50%) are used. Next, a thinning operation is performed on image edge portion data 4004 other than the in-image specified RGB data, using thinning masks 4016, 4018 (S805). As the thinning masks 4016, 4018, masks 2010, 2013 of FIG. 11 with a print possibility ratio of 75% (thinning ratio of 25%) are used. Next, using thinning masks 4020, 4022, a thinning operation is performed on character/line non-edge portion data 4005 (S806). Masks 2014, 2017 shown in FIG. 11 with a print possibility ratio of 75% (thinning ratio of 25%) are used as the thinning masks 4020, 4022. Next, using thinning masks 4024, 4026, a thinning operation is performed on in-image specified RGB non-edge portion data 4006 (S807). Masks 2018, 2021 shown in FIG. 11 with a print possibility ratio of 75% (thinning ratio of 25%) are used as the thinning masks 4024, 4026. Next, using thinning masks 4028, 4030, a thinning operation is performed on image edge portion data 4007 other than the in-image specified RGB data (S808). Masks 2018, 2021 shown in FIG. 11 with a print possibility ratio of 75% (thinning ratio of 25%) are used as the thinning masks 4028, 4030.

Of the thinned data produced by these thinning operations (S803-S808), the thinned data 4009, 4013, 4017, 4021, 4025, 4029 are combined (logically ORed) and transferred to the print head 201-1. Similarly, the thinned data 4011, 4015, 4019, 4023, 4027, 4031 are combined (logically ORed) and transferred to the print head 201-2.

Thus, the character/line data edge portions and edge portions of the in-image specified RGB value image have a maximum print duty of 100%, and other image edge portions a maximum print duty of 150%. The non-edge portions of an image have a print duty of up to 150% regardless of the kind of object and RGB value. As a result, the print duty of the character/line edge portions can be kept at an appropriate level. Further, since the print duty of edge portions of images having the specified RGB value can also be kept at an appropriate level, characters (black characters) included in bit map data can be prevented from spreading and bleeding at the edge portions. Furthermore, for character/line non-edge portions and specified RGB value image non-edge portions and for images other than the specified RGB value images, the printing is done at a print duty of up to 150%. It is therefore possible to form high-quality images at high grayscale levels.

As described above, in addition to character/line data included in the character/line objects, the fourth embodiment can also control the print grayscale level of black characters embedded in image data whose object information is not available, such as bit map image data. So, high-quality images with high grayscale levels can be formed while maintaining the sharpness of characters.

Although in the fourth embodiment the R, G, B=(0, 0, 0) is used as a specified RGB value, this invention is not limited to this example. For instance, images with an RGB value range of between R, G, B=(0, 0, 0) and R, G, B=(16, 16, 16) may be used as the specified RGB value images, and the maximum print duty may be differentiated between the specified RGB value images and other images.

### Other Embodiments

While the preceding embodiments have been described to use two ejection port arrays, three or more ejection port arrays of may be used for each kind of ink so that print data ejecting the same kind of ink may be divided among, and supplied to, three or more ejection port arrays. Further, while the print head for ejecting the same kind of ink has been shown to have two ejection port arrays, it is possible to provide two print heads with one ejection port array each and eject the same kind of ink from these two print heads.

In the above embodiments, the same kind of ink has been shown to be ejected from a plurality of ejection port arrays in order to enhance the print duty with a small number of scans. It is also possible to eject an individual ink from only one associated ejection port array. At this time, to print edge portions of image constitutional elements at a higher print duty than that of non-edge portions in one printing scan, the maximum print duty of the edge portions must be set lower than 100%. When the maximum print duty is set at a value in excess of 100%, a plurality of printing scans need to be performed on the same print area.

Another alternative may be to increase the number of ejection port arrays in only the print heads that eject ink for characters and lines.

It is needless to say that the object of this invention can be achieved by loading a storage medium having program codes of software that realizes the functions of the above embodiments into a system or equipment and by having a CPU or MPU execute the loaded program codes.

In that case, the program codes themselves, that were read out from the storage medium, realize the functions of the above embodiments and thus the storage medium storing the program codes constitutes this invention.

Storage media for supplying the program codes may include, for example, flexible disks, hard disks, optical discs, magneto-optical discs, CD-ROMs, CD-Rs, magnetic tapes, non-volatile memory cards and ROMs.

Further, this invention also includes a case where an operating system (OS) running on a computer executes a part or all of the processing based on instructions of program codes and thereby realizes the functions of the preceding embodiments.

It is also possible to adopt a construction in which the program codes read out from the storage medium are written into a memory installed on a function expansion board inserted in the computer or in a function expansion unit connected to the computer. In that case, a CPU in the function expansion board or function expansion unit may execute a part or all of the actual processing according to instructions of the program codes written into the memory and thereby realize the functions of the preceding embodiment. This configuration of course falls in the scope of this invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-249174, filed Sep. 26, 2007, which is hereby incorporated by reference herein in its entirety.

What is claimed is:

1. An ink jet printing apparatus that prints an image on a print medium by ejecting ink from a print head according to print data generated based on input image data, comprising:
a decision unit that decides attributes of the input image data corresponding to image constitutional elements making up the image;
a detector that detects the image constitutional elements as edge portions or non-edge portions; and
a generator that generates print data for printing the edge portions and print data for printing the non-edge portions based on attributes of the input image data corresponding to the image constitutional elements.

2. An ink jet printing apparatus according to claim 1, wherein the attributes of the input image data are attribute information representing characters, lines or images;
where the generator (A) generates print data for printing edge portions of the characters and print data for printing non-edge portions of the characters according to the input image data including the attributes of the characters, and (B) generates print data for printing edge portions of the images and print data for printing non-edge portions of the images according to the input image data including the attributes of the images.

3. An ink jet printing apparatus according to claim 2, wherein the generator generates print data for printing the edge portions of the images and print data for printing the non-edge portions of the images according to input image data having a predetermined RGB value among the input image data including the attributes of the images and generates print data for printing the edge portions of the images and print data for printing the non-edge portions of the images according to input image data other than the input image data having the predetermined RGB value among the input image data including the attributes of the images.

4. An ink jet printing apparatus according to claim 3, wherein the predetermined RGB value is an RGB value representing a black color.

5. An ink jet printing apparatus according to claim 4, wherein the RGB value representing the black color is R=G=B=0.

6. An ink jet printing apparatus according to claim 1, wherein the generator generates print data for printing the edge portions and print data for printing the non-edge portions so that a print duty of the edge portions is lower than that of the non-edge portions.

7. An ink jet printing apparatus according to claim 1, wherein the generator generates print data for printing the edge portions and print data for printing the non-edge portions so that a print duty of the edge portions is higher than that of the non-edge portions.

8. An ink jet printing apparatus according to claim 1, wherein the generator generates the print data so as to differentiate a print duty of the edge portions of the characters or lines from a print duty of the edge portions of the images and to differentiate a print duty of the non-edge portions of the characters or lines from a print duty of the non-edge portions of the images.

9. An ink jet printing apparatus according to claim 1, wherein the generator generates the print data so as to differentiate a print duty of the edge portions of a combined image of the characters and lines from a print duty of the edge portions of the images and to differentiate a print duty of the non-edge portions of a combined image of the characters and lines from a print duty of the non-edge portions of the images.

10. An ink jet printing apparatus according to claim 1, wherein the print head has a plurality of ejection port arrays to eject an ink of the same color and
further comprises a supply unit that divides the print data generated by the generator into pieces of print data corresponding to the plurality of ejection port arrays and that supplies the divided print data to the plurality of ejection port arrays.

11. An ink jet printing apparatus according to claim 1,
wherein the generator includes an edge portion thinning unit that thins edge portion data corresponding to the edge portion, and a non-edge portion thinning unit that thins non-edge portion data corresponding to the non-edge portion, and
wherein the print data for printing the edge portions is generated by thinning the edge portion data using the edge portion thinning unit and the print data for printing the non-edge portions is generated by thinning the non-edge portion data using the non-edge portion thinning unit.

12. An ink jet printing apparatus to print an image on a print medium by ejecting ink from a print head according to print data generated based on input image data, comprising:
a decision unit that decides attributes of the input image data corresponding to image constitutional elements making up the image;
a detector that detects the image constitutional elements as edge portions or non-edge portions; and
a thinning unit that thins the non-edge portion data corresponding to the pixels adjoining the edge portions at a thinning ratio that matches an attribute of input image data corresponding to the image constitutional elements.

13. An ink jet printing method that prints an image on a print medium by ejecting ink from a print head according to print data generated based on input image data, comprising the steps of:
checking attributes of the input image data corresponding to image constitutional elements making up the image;
detecting the image constitutional elements as edge portions or non-edge portions; and
generating print data for printing the edge portions and print data for printing the non-edge portions based on attributes of the input image data corresponding to the image constitutional elements.
